(19) United States
(12) Patent Application Publication
(10) Pub. No.: US 2012/0147389 A1
(43) Pub. Date: Jun. 14, 2012

(54) CALIBRATION FOR MAINTAINING QUALITY OF IMAGE

(75) Inventor: Takahiro Ishihara, Maebashi-shi (JP)

(73) Assignee: CANON KABUSHIKI KAISHA, Tokyo (JP)

(21) Appl. No.: 13/305,058

(22) Filed: Nov. 28, 2011

(30) Foreign Application Priority Data
Dec. 9, 2010 (JP) 2010-274918

(51) Int. Cl. G06K 15/02

(52) U.S. Cl. 358/1.2

(57) ABSTRACT

An image forming apparatus performs calibration to maintain a quality of an image by using a specific type of printing medium. A request unit requests a server apparatus for conversion setting information for converting a luminance value required to perform the calibration into a density value by using a printing medium whose type is different from the specific type. A reception unit receives the conversion setting information from the server apparatus. A storage unit stores the conversion setting information received from the server unit. A calibration performing unit performs calibration by using the conversion setting information stored in the storage unit and the printing medium whose type is different from the specific type.

### BACKGROUND OF THE INVENTION

1. Field of the Invention

The present invention relates to an image forming apparatus which performs calibration for maintaining the quality of images.

2. Description of the Related Art

The quality of images formed by an image forming apparatus varies due to the environment where the apparatus is used and the use situation of the apparatus. In addition, image quality also varies depending on the type of printing medium used. It is therefore necessary to change image converting conditions and image forming conditions depending on the environment and the use situation (U.S. Pat. No. 6,034,788). Likewise, it is necessary to add some image converting conditions and image forming conditions in accordance with the type of printing medium used (Japanese Patent Laid-Open No. 08-287217).

In U.S. Pat. No. 6,034,788, it is assumed that a specific type of printing medium is used every time calibration is performed. If, therefore, printing media of the specific type run out, the image forming apparatus cannot perform calibration. According to the invention disclosed in Japanese Patent Laid-Open No. 08-287217, in order to perform calibration with respect to an added arbitrary type of printing medium, it is necessary to prepare a printing medium of the same type for each calibration. In this case, the types of printing media include not only paper types such as plain paper and coated paper but also types classified according to the makers or brands. This is because even printing media classified as plain paper differ in their surface properties and degrees of white depending on the makers or brands. Performing calibration using a printing medium of a type different from the designated type of printing medium may, for example, make an amount of applied toner insufficient or exceed the allowable range designed for the image forming apparatus. This means that it is impossible to maintain image quality.

It would be convenient for the operator if it is possible to perform calibration with respect to a desired type of printing medium by using another type of printing medium. It would be convenient, in particular, if it is possible to additionally register, for calibration, a printing medium of a type different from the specific type of printing medium designated in advance by the maker or the like, without using the specific type of printing medium. In addition, simplifying additional registration operation can reduce the load on the operator.

### SUMMARY OF THE INVENTION

For example, a feature of the present invention is to perform calibration with respect to a given type of printing medium by using another type of printing medium. In particular, the present invention allows a printing medium of a type different from the specific type of printing medium designated in advance by the maker or the like to be added for the use of calibration.

The present invention provides an image forming apparatus performs calibration to maintain a quality of an image by using a specific type of printing medium. A request unit requests a server apparatus for conversion setting information for converting a luminance value required to perform the calibration into a density value by using a printing medium whose type is different from the specific type. A reception unit receives the conversion setting information from the server apparatus. A storage unit stores the conversion setting information received from the server unit. A calibration performing unit performs calibration by using the conversion setting information stored in the storage unit and the printing medium whose type is different from the specific type.

Further features of the present invention will become apparent from the following description of exemplary embodiments (with reference to the attached drawings).

### BRIEF DESCRIPTION OF THE DRAWINGS

FIG. 1 is a view showing an example of the arrangement of an image forming system including a color copying machine;

FIG. 2 is a block diagram of a reader image processing unit;

FIG. 3 is a block diagram of a printer control unit 109;

FIG. 4A is a flowchart showing contrast potential calculation processing in the first calibration;

FIG. 4B is a flowchart showing the second calibration;

FIG. 5A is a view showing an example of the first test pattern used in the first calibration;

FIG. 5B is a view showing an example of the first test pattern used in the second calibration;

FIG. 6 is a graph showing a relationship between a contrast potential and image density information;

FIG. 7 is a graph showing a relationship between a grid potential and a photosensitive drum surface potential;

FIG. 8 is a characteristic conversion chart showing the characteristics required to reproduce the density of a document image;

FIG. 9 is a graph for explaining the characteristic differences between printing media;

FIG. 10 is a flowchart showing additional registration operation for a printing medium;

FIGS. 11A and 11B are graphs for explaining a method of generating LUTid(Z) concerning an arbitrary printing medium Z;

FIG. 12 is a flowchart showing calibration using an added printing medium;

FIG. 13 is a flowchart showing additional registration operation for a printing medium using a data server;

FIG. 14A is a view showing an example of a message for prompting the operator to place a printing medium;

FIG. 14B is a view showing an example of an error message;

FIG. 15 is a block diagram showing an example of the arrangement of the data server;

FIG. 16A is a flowchart showing distribution operation for setting information which is performed by the data server;

FIG. 16B is a flowchart showing distribution operation for setting information which is performed by the data server;

FIG. 17 is a table showing comparison results on various types of calibrations;

FIG. 18 is a flowchart showing additional registration operation for a printing medium using the data server;

FIG. 19A is a view showing an example of a user interface for selecting the surface property of a printing medium to be added;

FIG. 19B is a view showing an example of a user interface for designating the grammage of a printing medium to be added;

FIG. 20A is a flowchart showing distribution operation for set information which is performed by the data server;

FIG. 20B is a flowchart showing registration operation for setting information which is performed by the data server;

FIG. 21 is a flowchart showing additional registration operation for a printing medium using the data server;

FIG. 22A is a view showing an example of a user interface for inquiring the operator whether to transmit setting information to the data server;

FIG. 22B is a view showing an example of an authentication window;

FIG. 23 is a graph showing a relationship (LUTid) between a read luminance value and a density value; and

FIG. 24 is a flowchart showing an example of averaging processing.

### DESCRIPTION OF THE EMBODIMENTS

Embodiments of the present invention will be described below. The individual embodiments described below will be useful in understanding various concepts of the present invention such as superordinate concepts, intermediate concepts, and subordinate concepts. Moreover, it should be understood that the technical scope of the present invention is defined by the appended claims and not limited by the individual embodiments below.

### First Embodiment

An embodiment in which the present invention is applied to an electrophotographic color copying machine will be described below. Note that the present invention can be applied to any image forming apparatuses which require calibration. That is, the image forming system is not limited to an electrophotographic system, and may be an ink jet system, an electrostatic printing system, or another system. The present invention can be applied to not only to an image forming apparatus which forms multicolor images but also to an image forming apparatus which forms monochrome images. An image forming apparatus may be commercialized as a printing apparatus, a printer, a copying machine, a multi-function peripheral, or a facsimile apparatus, for example. In addition, a printing medium may be referred to as a printing sheet, a printing material, paper, a sheet, a transfer material, or transfer paper. Furthermore, a material for a printing medium may be paper, fiber, film, resin, or the like.

<Basic Hardware Arrangement>

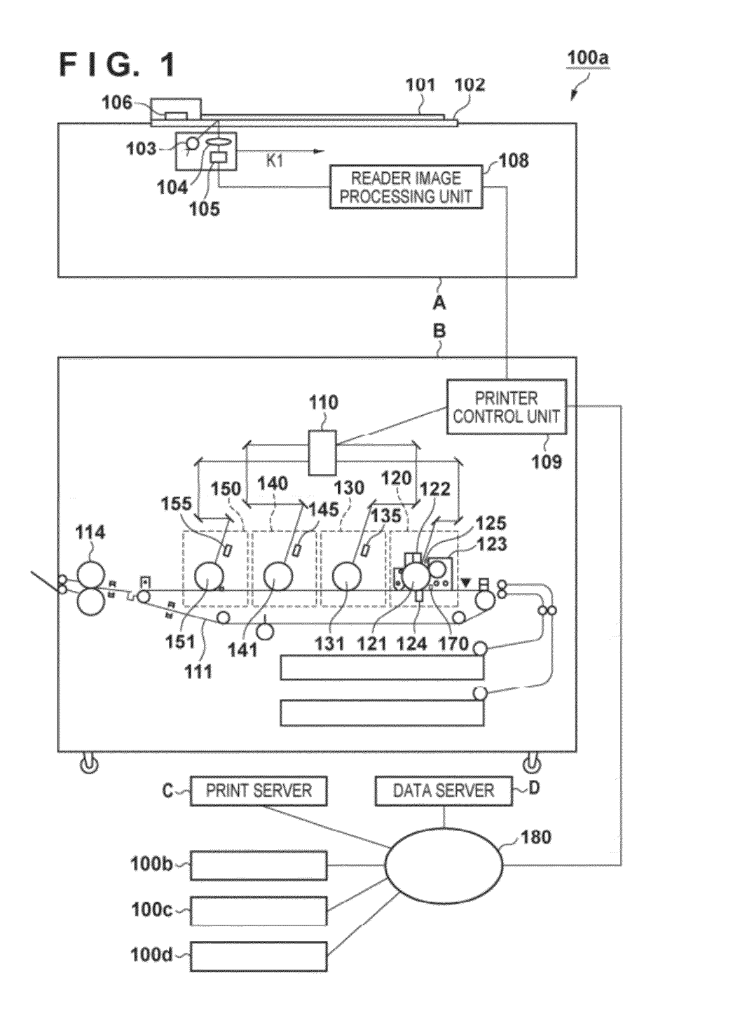

The image forming system according to this embodiment will be described with reference to FIG. 1. An image forming apparatus 100a shown in FIG. 1 is a copying machine including a reader unit A which reads an image from a document and a printer unit B which forms the image obtained by the reader unit A on a printing medium. The reader unit A is an example of an image read unit which reads the pattern image formed on a printing medium by the image forming unit and generates image data including luminance information. The reader unit A generates correction coefficients for so-called shading correction by reading a white reference board 106 before reading a document 101 placed on a document table glass 102. A light source 103 irradiates the document 101 with light. The reflected light is formed into an image on a CCD sensor 105 through an optical system 104. A read unit such as the CCD sensor 105 moves in the direction indicated by an arrow K1 to convert the document 101 into an electrical signal data string line by line. Note that the document 101 may move instead of the read unit. A reader image processing unit 108 converts each electrical signal data string into an image signal.

Note that the image forming apparatus 100a is connected to a print server C, a data server D, and other image forming apparatuses 100b, 100c, and 100d via a communication line 180 such as a network or public switched telephone network. The print server C transmits the image signal received from a host computer to a printer control unit 109. The printer unit B performs image formation based on the image signal. The printer unit B performs image formation operation based on not only an image signal from the print server C but also an image signal from the reader unit A. The data server D is a server apparatus which operates in cooperation with the image forming apparatuses 100a to 100d, and is an information processing apparatus which receives, computes, and transmits conversion setting information (for example, a lookup table) corresponding to an arbitrary type of printing sheet (to be described later) with respect to the image forming apparatuses 100a to 100d. Note that in this embodiment, the print server C and the data server D are implemented by physically different hardware apparatuses, but may be implemented by the same hardware. Likewise, the data server D may be mounted in either of the image forming apparatuses. This is because the data server D can be placed at any position as long as it is placed at a position on a network at which it can transmit and receive conversion setting information to and from an image forming apparatus. Providing the data server D outside the image forming apparatus with a storage device which stores conversion setting information as in this embodiment can improve the manageability, versatility, and accessibility of data.

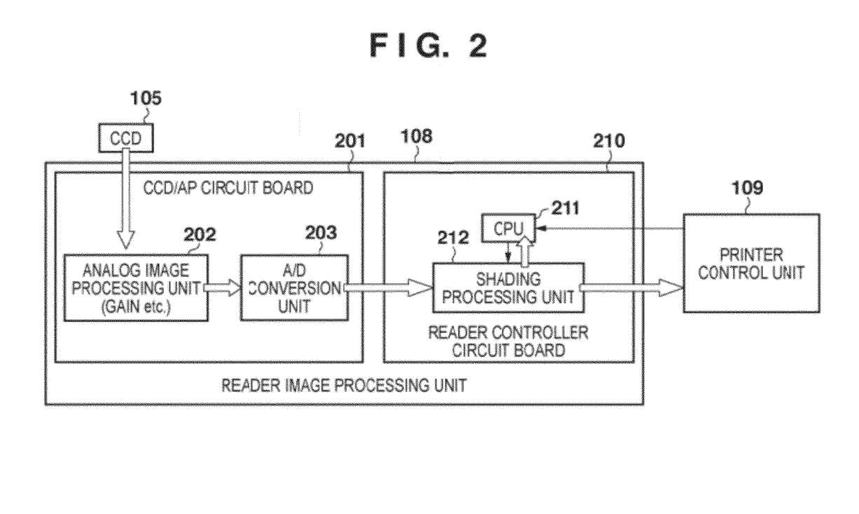

The reader image processing unit will be described with reference to FIG. 2. An analog image processing unit 202 of a CCD/AP circuit board 201 performs gain adjustment for the image signal obtained by the CCD sensor 105. An A/D conversion unit 203 converts the resultant signal into a digital image signal and outputs it to a reader controller circuit board 210. A shading processing unit 212 provided on the reader controller circuit board 210 performs shading correction for the image signal and outputs the resulting signal to the printer control unit 109 of the printer unit B under the control of a CPU 211. At this time point, the image signal is constituted by pieces of R, G, and B luminance information.

The printer unit B will be described next. Referring to FIG. 1, the printer control unit 109 converts an image signal into a PWM (pulse-width modulated) laser beam. A polygon scanner 110 deflects the laser beam, which in turn scans and exposes the image formation surfaces of photosensitive drums 121, 131, 141, and 151 of image forming units 120, 130, 140, and 150. This forms electrostatic latent images. The image forming units 120, 130, 140, and 150 respectively correspond to yellow (Y), magenta (M), cyan (C), and black (K). Since the image forming units 120, 130, 140, and 150 have almost the same arrangement, only the image forming unit 120 corresponding to yellow will be described. These image forming units each are an example of an image forming unit which forms a predetermined pattern image on a printing medium in accordance with a preset contrast potential. A primary charger 122 charges the surface of the photosensitive drum 121 to a predetermined potential. A developing device 123 forms a toner image by developing an electrostatic latent image on the photosensitive drum 121. A transfer blade 124 discharges a transfer belt 111 from the rear surface to transfer the toner image on the photosensitive drum 121 onto a printing medium. Thereafter, a fixing device 114 fixes the toner image on the printing medium.

The photosensitive drums 121, 131, 141, and 151 are respectively provided with surface potentiometers 125, 135, 145, and 155 for measuring surface potentials. The surface potentiometers 125, 135, 145, and 155 are used to adjust contrast potentials.

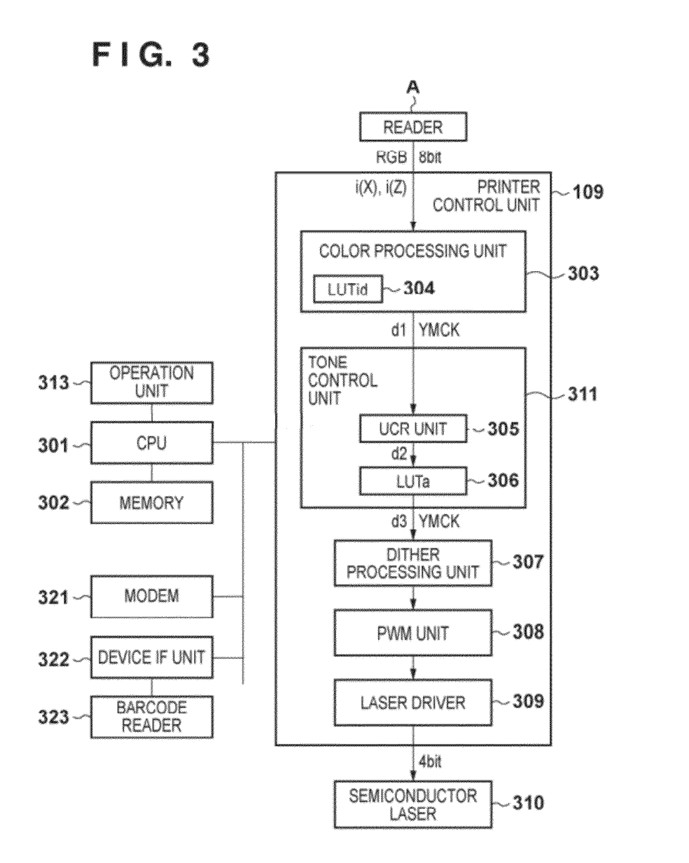

A CPU 301 comprehensively controls the respective units of the printer control unit 109 shown in FIG. 3. A control unit may be implemented by hardware such as an ASIC (Application Specific Integrated. Circuit) in place of the CPU 301. A memory 302 comprises a ROM and a RAM, and stores control programs and various kinds of data. A color processing unit 303 of the printer control unit 109 receives the image signal processed by the reader unit A, the print server C, or the like. Let i(X) be the luminance value of an image signal which is obtained from the patches formed on a printing medium X, and i(Z) be the luminance value of an image signal which is obtained from the patches formed on a printing medium Z.

The color processing unit 303 is a conversion unit which converts the luminance information contained in image data into density information by using luminance/density conversion setting information (LUTid 304) for converting luminance information into density information. The LUTid 304 is a luminance/density conversion table which converts the luminance information contained in an image signal from the reader unit A into density information. The LUTid 304 is prepared for a specific type of printing medium at first. In this embodiment, however, when the operator performs adding operation for an arbitrary type of printing medium, the LUTid 304 for the arbitrary type of printing medium is added. It is possible to perform adding operation by a method of downloading LUTid from the data server D to the image forming apparatus or a method of causing the image forming apparatus to generate LUTid.

In this embodiment, the CPU 301 switches the pieces of LUTid 304 for each type of printing medium used. When, for example, performing calibration by using a specific type of printing medium X, the apparatus uses LUTid(X). In addition, when performing calibration by using an arbitrary type of printing medium Z, the apparatus uses LUTid(Z). This makes it possible to perform calibration by using the printing medium Z instead of the printing medium X.

In this manner, the color processing unit 303 converts luminance information i(X) obtained by reading the pattern image formed on the printing medium X into density information d(X) by using the LUTid(X). The color processing unit 303 also converts luminance information i(Z) obtained by reading the pattern image formed on the printing medium Z of a type different from that of the printing medium X into density information d(X) by using the LUTid(Z). LUT is an abbreviation of lookup table. Note that luminance/density conversion setting information need not be expressed in an LUT table format but may be expressed by a function or a program code. The color processing unit 303 applies image processing and color processing to an input image signal so as to obtain a desired output when the output characteristics of the printer unit B are ideal. Although the tone count of the input signal is 8 bits, the color processing unit 303 converts the signal into a 10-bit signal to improve the accuracy. Each piece of Y, M, C, and K density information output from the color processing unit 303 is defined by d1.

A tone control unit 311 includes a UCR unit 305 and an LUTa 306, and corrects an image signal so as to match the printer unit B with ideal characteristics. The LUTa 306 is a 10-bit conversion table for correcting density characteristics, and is used to change the γ characteristic of the printer unit B, in particular. The tone control unit 311 is a conversion unit which converts density information into the output density of the image forming unit by using conversion setting information (LUTa) for the adjustment of the tone characteristics of the image forming unit. The tone control unit 311 performs UCR processing (UCR unit 305) and tone correction (LUTa 306) for the density signal converted by the color processing unit. The LUTa 306 is generated to optimize the characteristics of the printer unit B. The LUTa 306 is calibrated in accordance with the characteristics of the engine of the printer unit B which have varied according to the installation environment and over time.

The UCR unit 305 is a restriction unit which restricts the sum total of the output densities of the respective colors from exceeding a predetermined upper limit. More specifically, the UCR unit 305 is a circuit which limits the sum total of image signal levels by restricting the integrated value of image signals in each pixel. When the sum total exceeds a specified value, the UCR unit 305 performs undercolor removal processing (UCR) of converting a predetermined amount of CMY signal into a K signal to decrease the sum total of image signal levels. Assume that the upper limit is 280%. In this case, when a signal with Y=100%, M=100%, C=100%, and K=0% is input, the integrated value becomes 300% and exceeds the specified value. A portion in which Y, M, and C components equal in signal level are formed undergoes no change in color even if the portion is replaced by K. The UCR unit 305 therefore decreases each of the Y, M, and C levels by 10%, and increases the K level by 10%. That is, Y=90%, M=90%, C=90%, and K=10%, thus maintaining the integrated value at 280% without changing the color. To restrict the sum total of image signal levels is to restrict the amount of applied toner in image formation by the printer unit B. To optimize the operation of the printer unit B in this embodiment is to prevent image defects caused when the amount of applied toner exceeds a specified value.

The UCR unit 305 converts input density information d1 into density information d2. The LUTa 306 converts the density information d2 into density information d3. Note that in a calibration step and printing medium addition step (to be described later), this apparatus does not perform tone correction using the LUTa 306. The density information d2 is output to a dither processing unit 307 without any change. The dither processing unit 307 performs dither processing for the signal output from the tone control unit 311. A PWM unit 308 performs pulse width modulation of the resultant signal. A laser driver 309 causes a semiconductor laser to emit light by using the PWM-modulated signal. For this purpose, the dither processing unit 307 performs halftone processing for converting a 10-bit image signal into 4-bit data.

An operation unit 313 includes an input unit which inputs information and an output unit which outputs information, and is, for example, a touch panel display. A modem 321 is a communication device for communicating with the data server D via a public switched telephone network. Note that the modem 321 may be a LAN interface. A device interface unit 322 is an interface such as a USB interface, serial interface, or parallel interface, which is capable of connecting computer peripheral devices. A barcode reader 323 is a reading device for reading brand information in a barcode form representing the type of printing medium.

<Control of Image Forming Conditions>

This embodiment can perform calibration by using an arbitrary type of printing medium prepared by the user.

Calibration to be performed when a specific type of printing medium X set in advance is used will be described first. The printing medium X is, for example, a printing medium designated by the maker of the image forming apparatus at the time of shipment or a printing medium designated by a maintenance person at the time of maintenance. This embodiment includes the first calibration function of adjusting a contrast potential and the second calibration function of adjusting the γ correction circuit (LUTa) of the tone control unit 311. The CPU 301 functions as a control unit which controls calibration for adjusting the LUTa to maintain the quality of the images formed by the printer unit B.

I. First Calibration

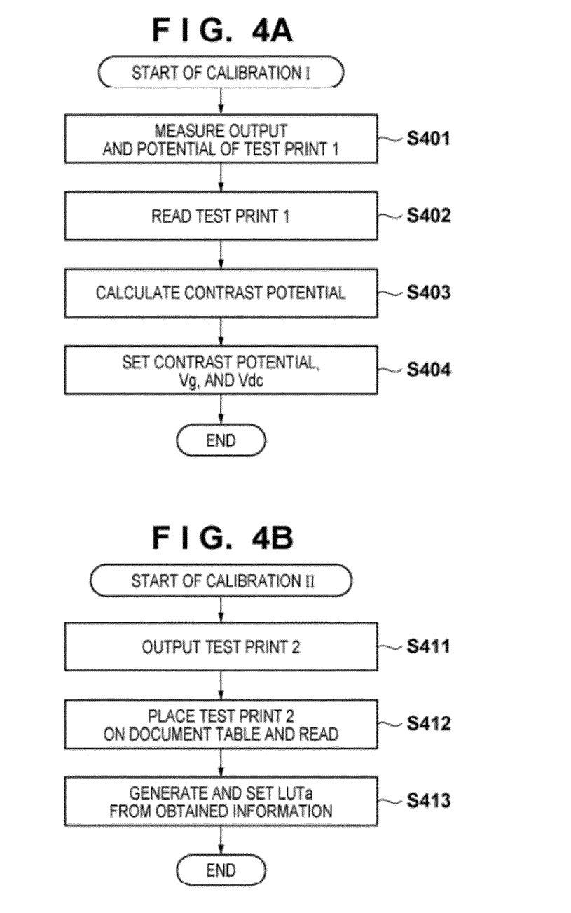

In FIG. 4A, the CPU 301 functions as the first calibration unit which performs the first calibration for determining a contrast potential by using the first luminance information obtained from the image formed on the specific type of printing medium. The CPU 301 also functions as a unit which performs the first calibration as one of a plurality of types of calibrations so as to make the printer unit B form the first pattern image and to determine a contrast potential based on the formed first pattern image.

In step S401, the CPU 301 outputs the first test print and performs measurement on the surface potentials of the photosensitive drums. For example, the CPU 301 generates the image data of the first test pattern (density information d1 of YMCK data) and outputs the data to the tone control unit 311, thereby forming the first test pattern as an image on the specific type of printing medium X. It is possible to store this image data in the ROM of the memory 302 in advance instead of forming it by the CPU 301. At this time, the CPU 301 controls the tone control unit 311 so as to inhibit the LUTa 306 from affecting the image data. The printing medium X on which the image of the first test pattern is formed is the first test print. Note that the CPU 301 sets, as a contrast potential used to output the first test print, an initial value expected to reach a target density in the atmospheric environment (for example: absolute amount of water) at this time. Assume that the memory 302 stores the values of contrast potentials respectively corresponding to various atmospheric environments. The CPU 301 measures the absolute amount of water and determines a contrast potential corresponding to the measured absolute amount of water.

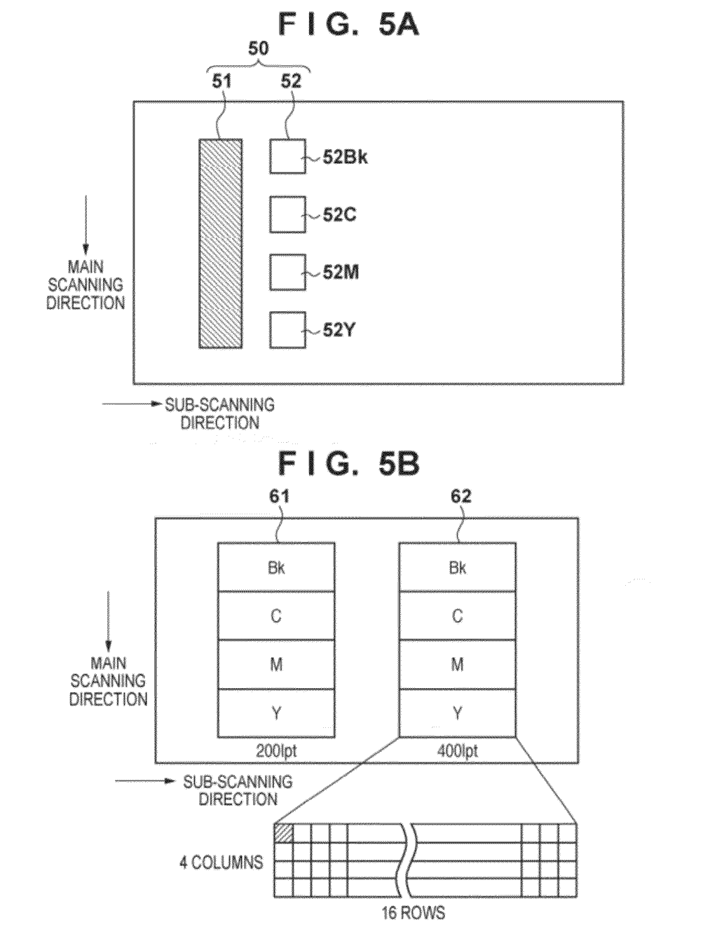

As shown in FIG. 5A, a first test pattern 50 is an example of the first pattern image including a band pattern 51 and a patch pattern 52. The band pattern 51 is a band-like pattern constituted by Y, M, C, and K halftone densities. The patch pattern 52 is constituted by patch patterns 52Y, 52M, 52C, and 52K respectively formed from Y, M, C, and K maximum density patches (for example, 255-level density signals). The surface potentiometers 125, 135, 145, and 155 measure actual contrast potentials when the respective maximum density patches are formed.

In step S402, the reader unit A reads the output first test print, and outputs the R, G, and B values to the printer control unit 109. The color processing unit 303 converts the R, G, and B values into density values by using the LUTid(X) prepared in advance in accordance with the specific type of printing medium X.

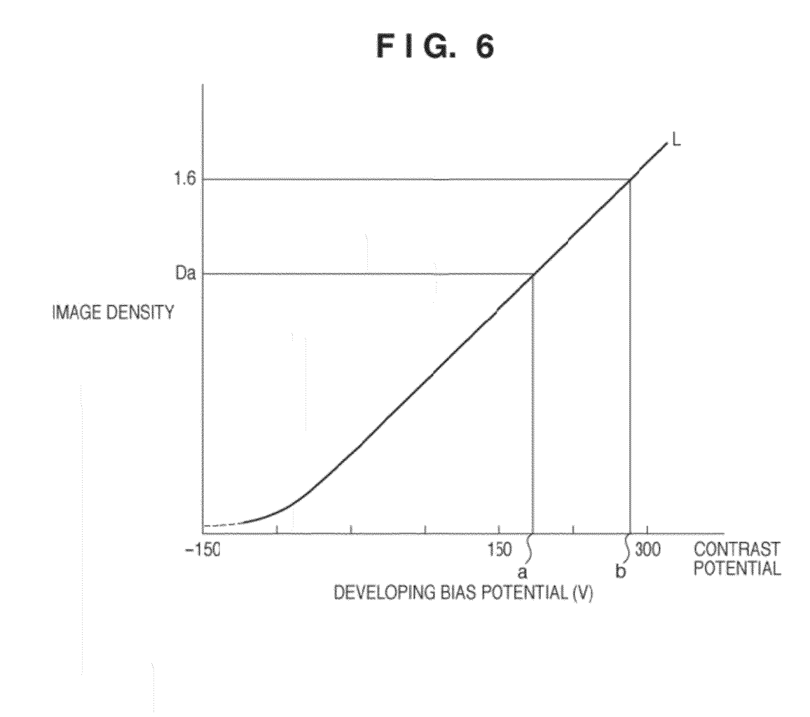

In step S403, the CPU 301 calculates a contrast potential b corresponding to the target maximum density based on the converted density value. The abscissa in FIG. 6 represents a developing bias potential, and the ordinate represents an image density. A contrast potential is a difference between a developing bias potential and the surface potential of the photosensitive drum when a semiconductor laser 310 corresponding to each color emits light at the maximum level after the photosensitive drum is primarily charged. Let Da be the maximum density obtained from the first test print formed by using a contrast potential a. In this case, near the maximum density (density of 0.8 to 2.0), the image densities are linearly expressed like a solid line L with respect to the contrast potential. The solid line L is determined based on the contrast potential a and a maximum density Da. In the this embodiment, the target maximum density is set to 1.6 as an example. The CPU 301 calculates the contrast potential b corresponding to the target maximum density based on the solid line L. It is assumed that a table or a function corresponding to the solid line L is stored in the memory 302 in advance. The contrast potential b is calculated by, for example,

b=(a+ka)×1.6/Da (1)

where ka is a correction coefficient, and is a value determined by the type of developing system.

In S404, the CPU 301 determines and sets a grid potential Vg and a developing bias potential Vds from the contrast potential b.

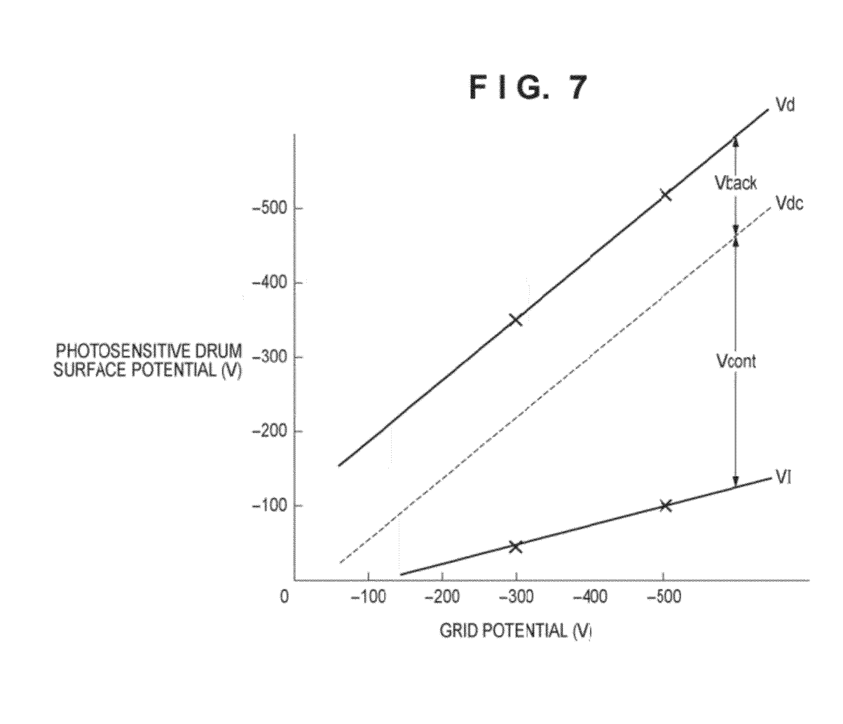

According to FIG. 7, the CPU 301 sets the grid potential Vg to −300 V, performs scanning with the semiconductor laser 310 of each color whose emission pulse level is minimized, and measures a surface potential Vd with each of the surface potentiometers 125, 135, 145, and 155. Furthermore, the CPU 301 sets the grid potential Vg to −300 V, measures a surface potential Vl with each of the surface potentiometers 125, 135, 145, and 155 when the emission pulse level of the semiconductor laser 310 of each color is maximized. Likewise, the CPU 301 measures surface potentials Vd and Vl when the grid potential Vg is set to −700 V. The CPU 301 can obtain the relationship between the grid potential and the photosensitive drum surface potential shown in FIG. 7 by interpolating or extrapolating the data obtained in the case of −300 V and the data obtained in the case of −700 V. The control for obtaining such potential data will be referred to as potential measurement control.

A contrast potential Vcont is determined as the difference voltage between a developing bias Vdc and the surface potential Vl. The maximum density can be set higher as the contrast potential Vcont increases. The CPU 301 determines the grid potential Vg corresponding to the determined contrast potential b (=Vcont) from the relationship shown in FIG. 7. The CPU 301 determines the corresponding surface potential Vd from the determined grid potential Vg and the relationship shown in FIG. 7. Furthermore, the CPU 301 determines the developing bias Vdc by subtracting Vback (for example, 150 V) from the surface potential Vd. Vback is a constant potential determined in advance to prevent fogging toner from adhering to an image.

II. Second Calibration

As is well known, an image forming apparatus such as a copying machine forms a copy (output image) by reading a document image. That is, the density (tone characteristic) of the document image needs to match the density (tone characteristic) of the output image. In the process performed by the copying machine, the reader unit A converts the document image into a luminance signal, and then converts it into a density signal corresponding to the luminance signal. The density signal is converted into a laser output signal corresponding to the amount of applied toner. The apparatus then irradiates the image carrier with a laser beam corresponding to the laser output signal to form an electrostatic latent image. The apparatus develops the electrostatic latent image into a toner image with toner. The apparatus transfers the toner image onto a printing medium, and fixes it by using the fixing unit, thereby forming an output image.

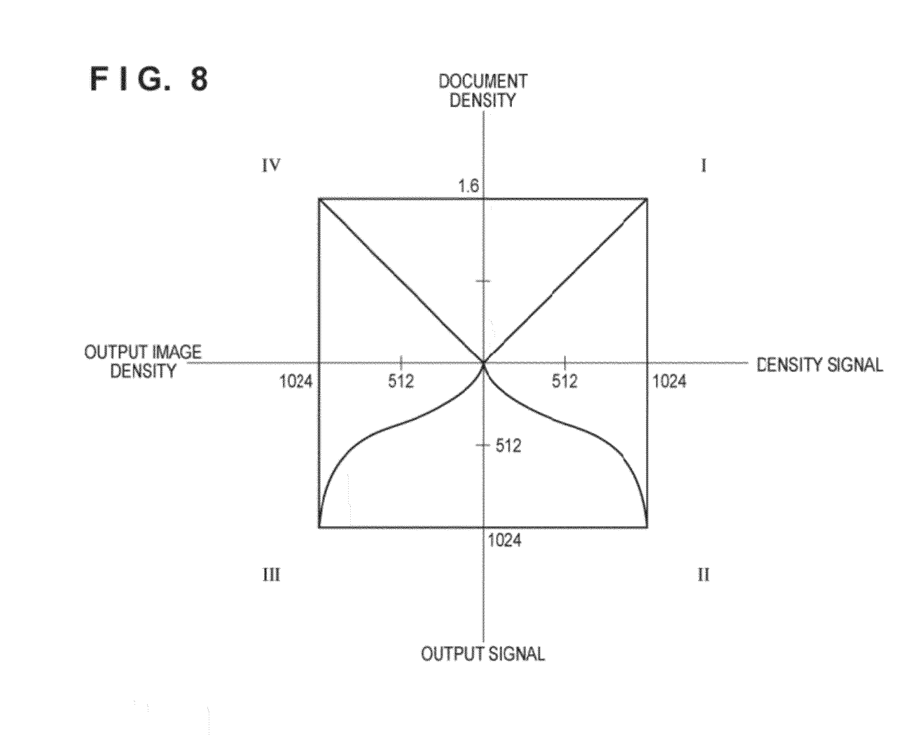

FIG. 8 shows a relationship between signals in a series of copy process of forming an output image from a document. A region I represents the characteristics of the reader unit A which converts the document density into a density signal. Note that the document density is expressed as an optical density obtained by reading the document using an optical densitometer. The tone count of the density signal is 1,024. A region II represents the characteristics of the tone control unit 311 (LUTa 306) which converts the density signal into a laser output signal. The tone count of the laser output signal is also 1,024. A region III represents the characteristics of the printer unit B which converts the laser output signal into an output image density. The output image density is sometimes called a printing density. The tone count of the output image density is 1,024. The region III represents the characteristics of the printer unit B which converts a laser output signal into an output density. A region IV represents the relationship between the document density and the printing density. This relationship represents the overall tone characteristic of the image forming apparatus 100a according to the embodiment.

To linearize the tone characteristic in the region IV, the image forming apparatus 100a corrects the distortion of the printing characteristic of the printer unit B in the region III by the tone control unit 311 in the region II. It is possible to easily generate the LUTa 306 only by replacing the input with the output of the characteristic in the region III obtained when outputting a test print without making the tone control unit 311 operate. That is, the pattern image on the test print includes a plurality of patches of different tones. Obviously, the amount of applied toner (output signal) used to form each patch is already known. On the other hand, the reader unit A reads the density of each patch as luminance information and converts the information into a density signal by the LUTid 304. This obtains the relationship between the different amounts of applied toner (output signals) provided as inputs and the density signals (density values) as corresponding outputs. Therefore, reversing the relationship between the input and the output can obtain the amount of applied toner (output signal) that should be output when a given density signal is provided as an input. That is, the LUTa 306 represents the relationship between the density signal and the output signal. Note that in this embodiment, although the output tone count is 256 (8 bits), since the tone control unit 311 processes a digital signal with 10 bits, the tone count of the tone control unit 311 is 1,024. Note that these tone counts are merely examples.

Referring to FIG. 4B, the CPU 301 performs second calibration as one of a plurality of types of calibrations. The CPU 301 functions as a unit which causes the printer unit B to form a pattern image on a specific type of printing medium X designated in advance, obtains the relationship between the optical density and the output density from the pattern image formed on the specific type of printing medium X, and generates conversion setting information based on the obtained relationship. In general, the CPU 301 performs the second calibration after the end of the first calibration.

In step S411, the CPU 301 outputs the second test print. For example, the CPU 301 generates the image data (YMCK density information d1) of the second test pattern and outputs it to the tone control unit 311, thereby forming, as an image, the second test pattern on the specific type of printing medium X. It is possible to store this image data in the ROM of the memory 302 instead of making the CPU 301 generate it. The printing medium X on which the image of the second test pattern is formed is the second test print. At this time, the CPU 301 performs image formation without making the LUTa of the tone control unit 311 operate.

The density signals Y, M, C, and K output from the UCR unit 305 are input to the dither processing unit 307 while detouring the LUTa 306.

On the second test print, for example, a second test pattern (patch groups 61 and 62) having 4 columns×16 rows (that is, 64 tones) of gradation data for each of Y, M, C, and K is formed, as shown in FIG. 5B. The second test pattern is an example of the second pattern image. For example, low-density regions of a total of 256 tones can be assigned to the 64-tone patches. This makes it possible to properly adjust the tone characteristic of the highlighted portion. Note that it is possible to prepare two second test patterns including the second test pattern for low resolutions (160 to 180 lpi) and that for high resolutions (250 to 300 lpi). Referring to FIG. 5B, the former is the patch group 61, and the latter is the patch group 62. “Lpi” stands for lines/inch. To form an image of each resolution, the dither processing unit 307 performs dither processing using parameters corresponding to the resolution. Note that a tone image is formed with a resolution of about 160 lpi to 180 lpi, and a line image such as a character is formed at a resolution of about 250 to 300 lpi. Test patterns of the same tone level are output with the two resolutions. If the tone characteristic greatly changes due to the difference in resolution, the tone level is set in accordance with the resolution. If the printer unit B has an ability to form images with three or more types of resolutions, the test print for the second calibration may be divided into a plurality of pages.

In step S412, the reader unit A reads an image from the second test pattern. The R, G, and B luminance values output from the second test pattern are input to the color processing unit 303. The color processing unit 303 converts the R, G, and B luminance values into density values using the LUTid (X). The reason why the LUTid(X) is used is that the printing medium X is used.

In step S413, the CPU 301 generates a table representing the relationship between laser output level and density by associating the laser output levels used to generate the second test pattern with the generation positions of test patterns (patches). The CPU 301 writes the generated table in the memory 302. At this stage, the CPU 301 can obtain the characteristics of the printer unit B in the region III of FIG. 8. The LUTa of the printer unit B is determined by replacing the input with the output of the characteristics, and is set in the tone control unit 311. In some cases, the amount of data obtained is too small to obtain LUTa by computation. This is because tone patches of only 64 tones are generated although data of 256 tones are originally required. The CPU 301 therefore generates necessary data by interpolating lacking data. Using such second calibration will adjust the tone control unit 311 to linearize the relationship between input density and output density. More specifically, when the CPU 301 starts calibration processing for adjusting the LUTa, the printer unit B forms a pattern image on the specific type of printing medium X. The reader unit A outputs the luminance information i(X) by reading the pattern image formed on the specific type of printing medium. In addition, the color processing unit 303 converts the luminance information i(X) into the density information d(X) by the using LUTid(X). The document 101 generates LUTa by using the density information d(X) as input values, and the amounts (t(x)) of applied toner, as output values, which were used when the printer unit B formed a pattern image on the specific type of printing medium X.

This embodiment has exemplified the case in which the apparatus sequentially performs the first calibration and second calibration. It is, however, possible to individually perform one of the calibrations. In this embodiment, performing calibration makes it possible to effectively correct variations in image density, image reproducibility, or tone reproducibility that can occur in a short or long term. It is therefore possible to maintain the image quality.

<Adding Operation for Arbitrary Type of Printing Medium>

A case in which a printing medium which can be used for calibration is added will be described next. A feature of this embodiment is to properly adjust the printer characteristics by calibration using an arbitrary type of printing medium Z.

Assume that the arbitrary type of printing medium Z which is different from the specific type of printing medium X is used for calibration expected to use the printing medium X. In this case, it is not possible to properly perform calibration. For the specific type of printing medium X, LUTid(X) is known. It is therefore possible to match a tone characteristic with a desired characteristic by performing calibration using the specific type of recording medium X. However, with regard to the arbitrary type of printing media Z, the relationship between the luminance and the density (the amount of applied toner) is unknown.

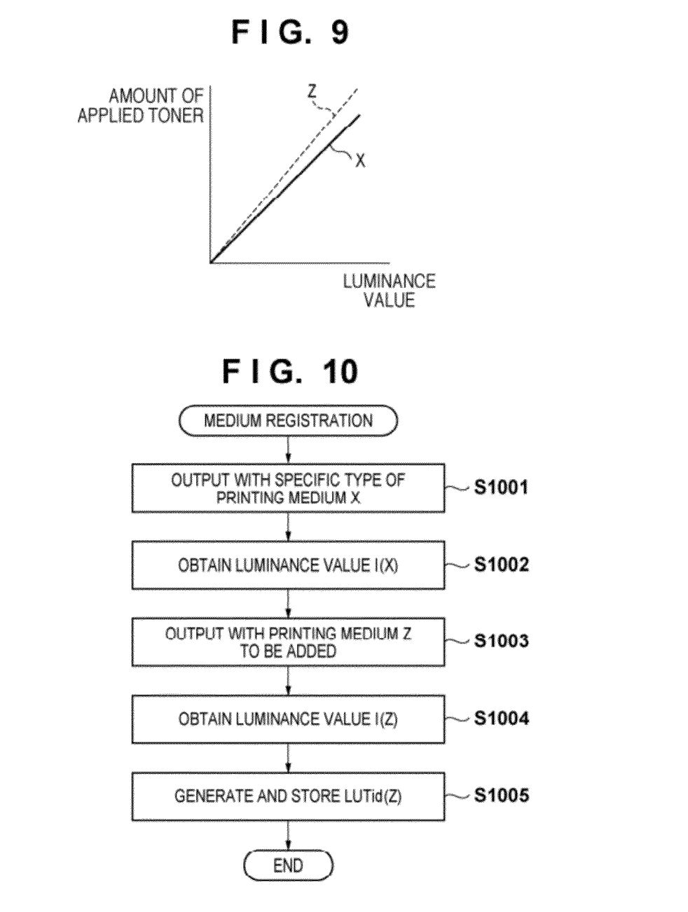

FIG. 9 exemplifies another type of printing medium Z whose luminance value read by the CCD sensor 105 is smaller than that read from the specific type of printing medium X when the amount of applied toner on the printing medium Z is equal to that on the printing medium X. That is, with regard to the same luminance signal, the amount of applied toner on the printing medium Z is larger than that on the printing medium X. That is, it is not possible to implement proper calibration unless the luminance value of each patch read by the CCD sensor 105 is converted into a density value by using luminance/density conversion setting information in accordance with the type of printing medium.

In order to implement such calibration, this apparatus forms pattern images on the specific type of printing medium X and the arbitrary type of printing medium Z, respectively, by using the same image signal. The purpose of using the same image signal is to equalize the amounts of applied toner on the specific type of printing medium X and the arbitrary type of printing medium Z. The reader unit A reads images from the specific type of printing medium X and the arbitrary type of printing medium Z and determines the luminance values of the respective images. The CPU 301 further calculates the luminance difference between these luminance values and corrects the difference with LUTid. For example, the CPU 301 generates LUTid(Z) for the arbitrary type of printing medium Z by adding the difference to the LUTid(X) for the specific type of printing medium X.

When performing calibration by using the arbitrary type of printing medium Z, the apparatus sets the LUTid(Z) in the color processing unit 303. This can generate LUTa implementing a tone characteristic equivalent to that obtained by performing calibration using the specific type of printing medium X.

Referring to FIG. 10, when the operator designates additional registration for a printing medium for calibration by operating the buttons of the operation unit provided on the image forming apparatus 100a, the CPU 301 starts adding operation.

In step S1001, the CPU 301 selects the specific type of printing medium X and forms an image pattern on the specific type of printing medium X. It is possible to use, as an image pattern, for example, the second test pattern used for the second calibration. The printer unit B corresponds to an image forming unit which forms images on the specific type of printing medium X, which can be used for calibration, and the arbitrary type of printing medium Z by using the same image signal so as to add the arbitrary type of printing medium as a printing medium which can be used for calibration.

In step S1002, the reader unit A reads the image pattern formed on the specific type of printing medium X, generates a read luminance value I(x), and transfers it to the CPU 301 of the printer control unit 109. The luminance value I(x) is equivalent to the first luminance information obtained from the image formed on the specific type of printing medium.

In step S1003, the CPU 301 selects the arbitrary type of printing medium Z to be added, and forms the second test pattern on the printing medium Z.

In step S1004, the reader unit A reads the image pattern formed on the printing medium Z, generates read luminance information I(Z), and transfers it to the CPU 301 of the printer control unit 109. The luminance information I(Z) is equivalent to the second luminance information obtained from the image formed on the arbitrary type of printing medium. The image data and image processing used to obtain the read luminance information I(Z) are the same as those used to obtain the read luminance value I(x).

In step S1005, the CPU 301 generates LUTid(Z) used to perform calibration using the printing medium Z by applying the following method to the read luminance values I(x) and I(Z), and stores the LUTid(Z) in the memory 302 or the color processing unit 303. The following is a detailed method of forming LUTid(Z). Note that LUTid(Z) is equivalent to the second conversion setting information for converting the luminance information of the arbitrary type of printing medium Z into density information.

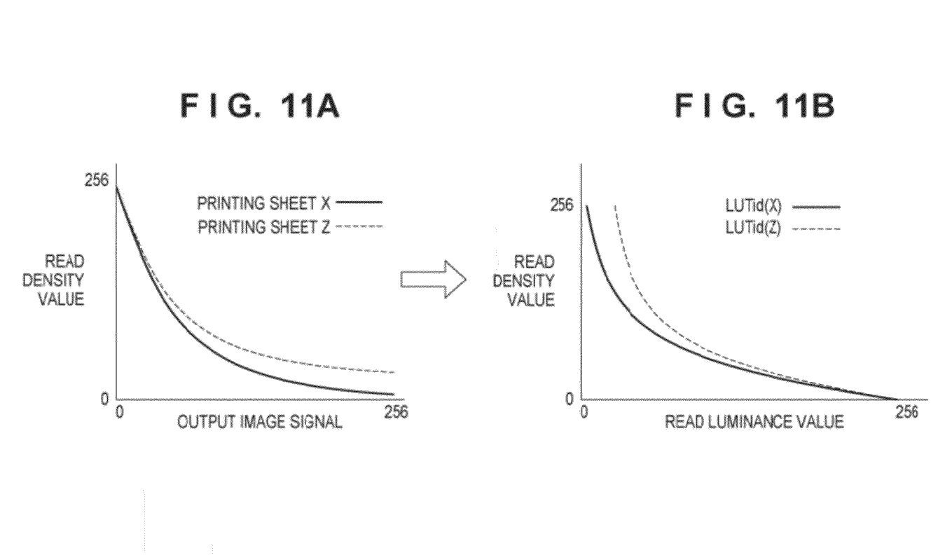

Refer next to FIGS. 11A and 11B. FIG. 11A shows the relationship between the output image signal and the read luminance value on the specific type of printing medium X and that on the arbitrary type of printing medium Z. FIG. 11B shows the relationship between the read luminance value and the read density value. Note that the density value of the printing medium Z is converted into the density value of the printing medium X.

The read luminance value I(x) of the specific type of printing medium X and the read luminance information I(Z) of the arbitrary type of printing medium Z are the luminance values read from the images formed on the printing medium X and printing medium Z using the same image signal (=same amount of applied toner). The CPU 301 calculates the luminance difference between the specific type of printing medium X and the arbitrary type of printing medium Z, which is required to achieve the same amount of applied toner. The CPU 301 therefore functions as a calculation unit which calculates the difference between the first luminance information and the second luminance information.

The CPU 301 generates LUTid(Z) for the arbitrary type of printing medium Z by adding this luminance difference to LUTid(X). The CPU 301 therefore functions as the second calculation unit which calculates the second conversion setting information by adding the difference to the first conversion setting information. LUTid(X) is equivalent to conversion setting information for converting the luminance information of the specific type of printing medium into density information.

Using the printing medium Z and LUTid(Z) as a pair in this manner can obtain the same calibration result as that obtained by using the printing medium X and LUTid(X) as a pair. This means that the LUTa determined by combining the printing medium Z and LUTid(Z) is substantially the same as the LUTa determined by combining the printing medium X and LUTid(X). That is, it is theoretically possible to obtain the LUTa even by using the arbitrary type of printing medium Z instead of the specific type of printing medium X. The LUTa corresponds to the characteristics indicated in the region II shown in FIG. 8. If, therefore, the printer characteristics indicated in the region III remain the same, LUTa(X) generated by using the printing medium X is identical to LUTa(Z) generated by using the printing medium Z. Therefore, the LUTa(Z) is equivalent to common image forming conditions applied to the specific type of printing medium and the arbitrary type of printing medium. The CPU 301 functions as a determination unit which determines image forming conditions based on the second conversion setting information. The CPU 301 stores the generated LUTid(Z) in the memory 302 in advance in association with the identification information of the added arbitrary type of printing medium Z.

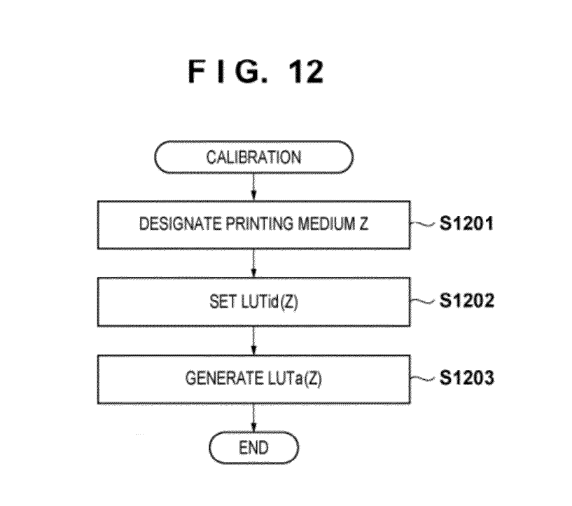

Referring to FIG. 12, in step S1201, the CPU 301 makes the operator designate which type of printing medium is to be used.

In step S1202, if the operator designates the printing medium X, the CPU 301 reads out the LUTid(X) from the memory 302, and sets it in the color processing unit. If the operator designates the printing medium Z, the CPU 301 reads out the LUTid(Z) from the memory 302, and sets it in the color processing unit. The CPU 301 therefore functions as a designation unit which designates a printing medium to be used for calibration.

In step S1203, the CPU 301 performs the first calibration (steps S401 to S404) and the second calibration (steps S801 to S803). The CPU 301 then generates LUTa(Z) by the second calibration, in particular. Note that the color processing unit 303 performs conversion processing by using LUTid corresponding to the printing medium designated by the CPU 301. The color processing unit 303 therefore functions as a conversion unit which converts the luminance information obtained from the image formed on a specific type of printing medium into density information by using the first conversion setting information when the specific type of printing medium is designated by the designation unit. The color processing unit 303 also functions as a conversion unit which converts the luminance information obtained from the image formed on an arbitrary type of printing medium into density information by using the second conversion setting information when the arbitrary type of printing medium is designated by the designation unit. As described above, the CPU 301 or the printer control unit 109 functions as a calibration performing unit which performs calibration by using the conversion setting information stored in the storage unit and a printing medium of a type different from a specific type of printing medium.

This embodiment generates the second conversion setting information (LUTid(Z)) for the printing medium Z from the characteristic (luminance value I(x)) of the specific type of printing medium X, the characteristic (luminance information I(Z)) of the arbitrary type of printing medium Z, and the first conversion setting information (LUTid(Z)) for the printing medium X. This makes it possible to perform calibration by using the arbitrary type of printing medium Z. Forming images on the printing medium X and the printing medium Z by using the same image signal, in particular, can equalize the amounts of applied toner on the two printing media. Since the amounts of applied toner on the two media are the same, the difference between the luminance value I(x) and the luminance value I(Z) corresponds to the difference between the LUTid(X) and the LUTid(Z). Adding the difference between the luminance value I(x) and the luminance value I(Z) to the LUTid(X) can relatively easily obtain LUTid(Z).

This apparatus further determines common image forming conditions (LUTa) applied to both the specific type of printing medium X and the arbitrary type of printing medium Z based on the second conversion setting information.

According to this embodiment, since it is possible to accurately set the monochrome output characteristic of the printer unit B in a desired state. It is therefore also possible to improve the color reproduction accuracy when the printer control unit 109, external controller, or the like performs color management using an ICC profile. Note that ICC stands for international color consortium.

This embodiment has exemplified the case in which in the printing medium adding operation, the apparatus performs image formation and reading on the printing medium Z after performing image formation and reading on the printing medium X. However, it is possible to perform image formation on the printing media X and Z first, and then performing image reading from the printing media X and Z. Either of the printing media X and Z can be processed first.

<Adding Operation for LUTid Using Data Server>

As described above, generating LUTid(Z) for the printing medium Z allows to perform calibration for maintaining the tone characteristic of the printing medium X by using the printing medium Z instead of the printing medium X. There are image forming apparatuses of the same model on the market, and they may use the same type of printing medium. It is therefore possible that any of these image forming apparatuses may have already generated LUTid(Z) for the printing medium Z. The generation of LUTid(Z) requires not only the printing medium X but also the generation time. If, therefore, an image forming apparatus of the same model can download LUTid(Z) which has already been generated for the printing medium Z, it is possible to eliminate the necessity of the printing medium X and shorten the generation time. In the first embodiment, therefore, when starting adding operation for the arbitrary type of printing medium Z, the CPU 301 tries to receive LUTid(Z) from the data server D. Upon successfully receiving LUTid(Z), the CPU 301 stores it in the memory. Upon failing to receive LUTid(Z), the CPU 301 generates LUTid(Z). Note that registering the generated LUTid(Z) in the data server D can reduce the processing load on another image forming apparatus.

[Procedure for Adding Operation Performed by Image Forming Apparatus]

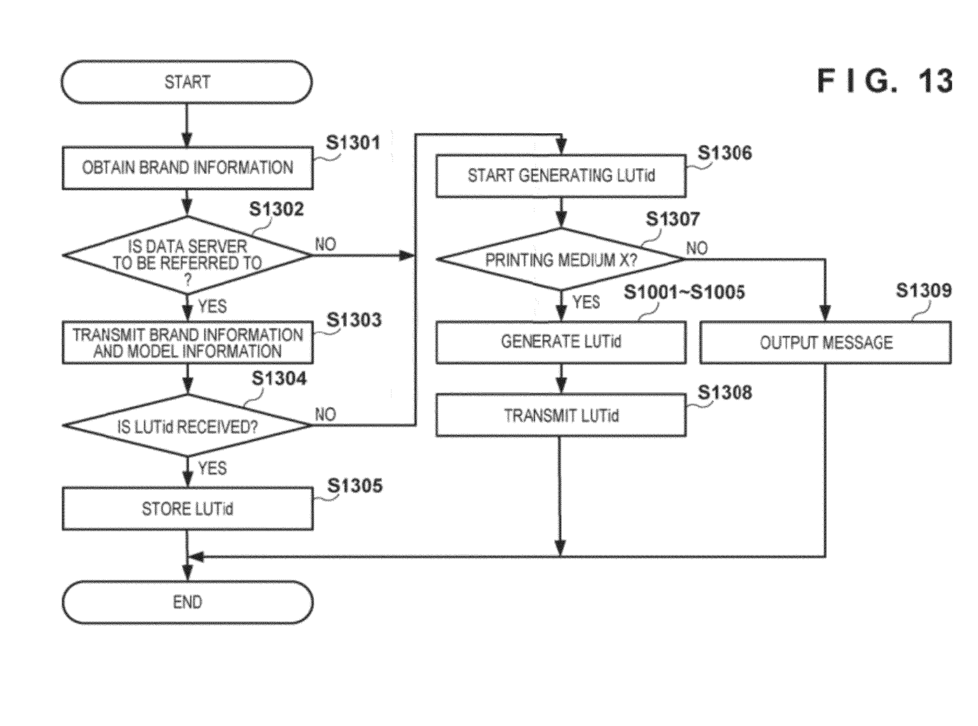

Calibration printing medium adding procedure performed by the image forming apparatus of this embodiment will be described with reference to FIG. 13. For the sake of simplicity, the same reference numerals denote the portions which have already been described. In this case, upon detecting the touch by the user on a button for designating the start of addition, which is displayed on the display unit of the operation unit 313, the CPU 301 starts this processing. The CPU 301 displays, on the display unit of the operation unit 313, a message to prompt the user to read brand information (barcode information) indicating the printing medium Z to be added with the barcode reader.

In step S1301, the CPU 301 temporarily stores the barcode information read by the barcode reader 323 in the memory 302. The CPU 301 displays the message on the display unit of the operation unit 313. This message is a message for making the user select whether to refer to LUTid in the data server D. In this manner, the CPU 301 or the barcode reader 323 functions as a brand information obtaining unit which obtains brand information indicating the brand of a printing medium of a type different from a specific type of printing medium. The barcode reader 323 is an example of a barcode reader which reads brand information in a barcode form indicating the brand of the printing medium.

In step S1302, the CPU 301 determines, based on the information input from the operation unit 313, whether to refer to LUTid in the data server D. When the CPU 301 detects a signal indicating that the user has operated the button for indicating an attempt to refer to, the process advances to step S1303. When the CPU 301 detects a signal indicating that the user has operated a button indicating an attempt not to refer to, the process advances step S1306.

In step S1303, the CPU 301 transmits a reference request to the data server D via the modem 321. For example, the CPU 301 reads out the brand information of the printing medium Z stored in the memory 302, and also reads out model information indicating the model of the image forming apparatus 100a stored in the memory 302. The CPU 301 generates and transmits a reference request containing or accompanied by brand information and model information. In this manner, the CPU 301 functions as a request unit which requests the server apparatus for conversion setting information for converting a luminance value to a density value, which is required when the apparatus performs calibration by using a printing medium whose type is different from the specific type. In the first embodiment, in particular, the CPU 301 functions as a request unit which requests the server apparatus for conversion setting information corresponding to brand information. The CPU 301 also functions as a model information obtaining unit which obtains model information indicating the model of the image forming apparatus. In addition, the CPU 301 functions as a request unit which requests the server apparatus for conversion setting information corresponding to model information, in addition to brand information. In this case, model information includes, for example, a product serial number, model number, and serial number. Although described in detail later, upon receiving a reference request, the data server D searches its memory area based on the brand information and the model information and tries to extract the corresponding LUTid. Upon finding the corresponding LUTid, the data server D transmits it to the image forming apparatus 100a. Upon finding no corresponding information, the data server D transmits a response indicating the failure to find such information to the image forming apparatus 100a.

In step S1304, the CPU 301 determines whether LUTid corresponding to the printing medium Z to be added could be received from the data server D. If the LUTid could be received together with a search success message, the process advances to step S1305.

In step S1305, the CPU 301 stores the received LUTid in the ROM portion of the memory 302 in association with the brand information of the printing medium Z, and then terminates this processing. This makes it possible to perform calibration by using the printing medium Z instead of the printing medium X. In this manner, the memory 302 functions as a storage unit which stores the conversion setting information received from the server apparatus. When brand information is input by using the barcode reader in step S1201 described above, LUTid corresponding to the brand information is set in step S1202, thereby generating LUTa in step S1203. If the CPU 301 receives a search failure message in step S1304, the process advances to step S1306.

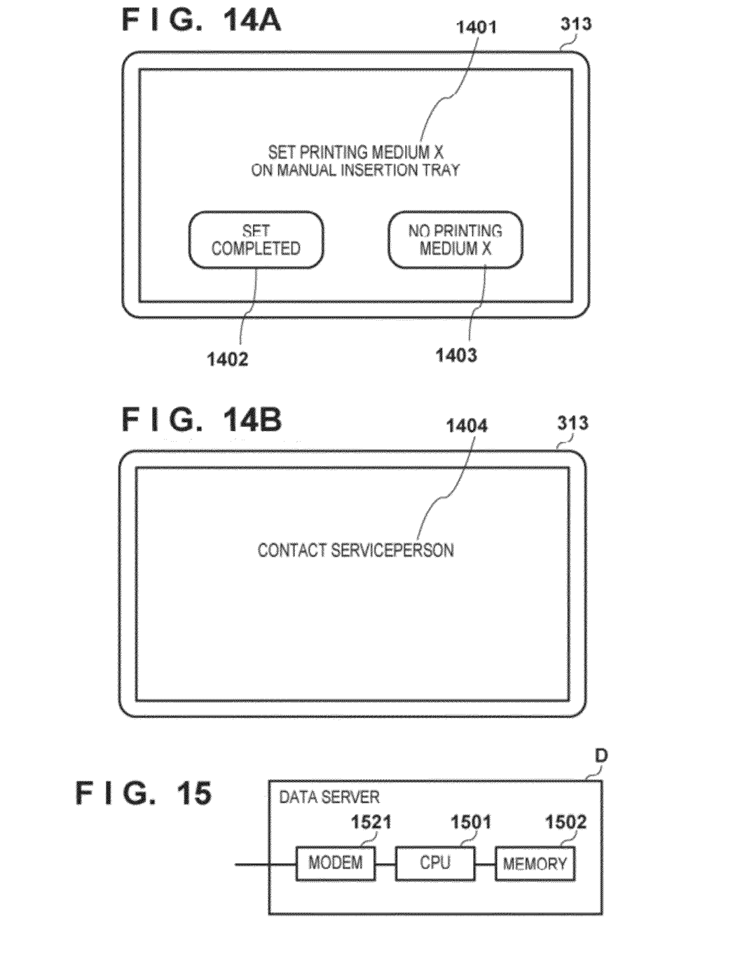

In step S1306, the CPU 301 starts generating LUTid(Z) corresponding to the printing medium Z. To generate LUTid(Z), the specific type of printing medium X is required as well as the printing medium Z. As shown in FIG. 14A, the CPU 301 displays a message 1401 and buttons 1402 and 1403 on the display unit of the operation unit 313. The message 1401 is a message for prompting the user to set (place) the printing medium X designated by the maker of the image forming apparatus 100a on a manual insertion tray. The button 1402 is a button for notifying the CPU 301 of the completion of setting of the printing medium X. The button 1403 is a button for notifying the CPU 301 that the operator cannot prepare the printing medium X.

In step S1307, the CPU 301 determines, based on the information input from the operation unit 313, whether the printing medium X is set on the tray. More specifically, upon detecting a signal indicating that the operator has operated the button 1402, the CPU 301 determines that the printing medium X is set on the tray. Upon detecting a signal indicating that the operator has operated the button 1403, the CPU 301 determines that the printing medium X is not set on the tray.

If the printing medium X is set on the tray, the CPU 301 generates LUTid(Z) by performing steps S1001 to S1005 described above. The process then advances to step S1308. In this manner, the CPU 301 functions as a generation unit which generates conversion setting information and makes the storage unit store it upon receiving no conversion setting information from the server apparatus.

In step S1308, the CPU 301 transmits (uploads) the generated LUTid(Z) and a registration request containing or accompanied by brand information and model information, and terminates this processing. The data server D registers LUTid(Z) in the database in association with the brand information and the model information. This database is a database which registers conversion setting information in association with brand information indicating the brand of each printing medium or physical characteristic information indicating the physical characteristics of each printing medium. This allows the image forming apparatuses 100b to 100d of the same model as that of the image forming apparatus 100a to download LUTid(Z) from the data server D and use it instead of generating it. In this manner, the CPU 301 functions as a transmission unit which causes the server apparatus to register conversion setting information by transmitting the conversion setting information generated by the generation unit.

If the printing medium X is not set on the tray (the button 1403 is operated), the process advances to step S1309. In step S1309, the CPU 301 outputs a message to the display unit of the operation unit 313. This message is a message explaining the operation to be performed by the operator when he/she cannot prepare the printing medium X, like a message 1404 shown in FIG. 14B. In this case, the message prompts the operator to contact with a serviceperson for the image forming apparatus, because he/she cannot generate LUTid because of the lack of the printing medium X.

[Procedure for Adding Operation Performed by Data Server D]

A procedure in the data server D which manages the pieces of conversion LUTid transmitted by a plurality of image forming apparatuses will be described below.

As shown in FIG. 15, in the data server D, a CPU 1501 operates in accordance with the programs stored in a memory 1502. The memory 1502 includes storage devices such as a RAM, ROM, and HDD (Hard Disk Drive). A modem 1521 is a communication device for communicating with the image forming apparatuses 100a to 100d via a public switched telephone network. Note that the modem 1521 may be a LAN interface.

<Response Processing for Reference Request>

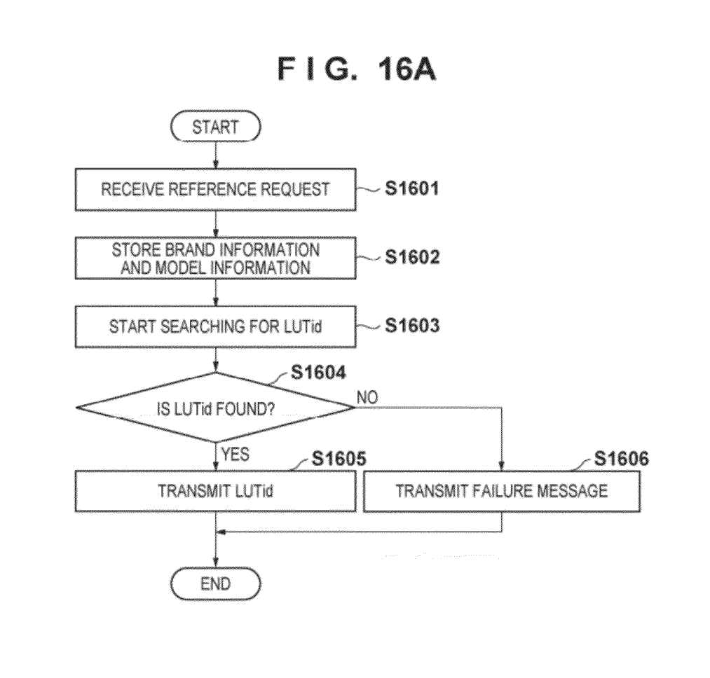

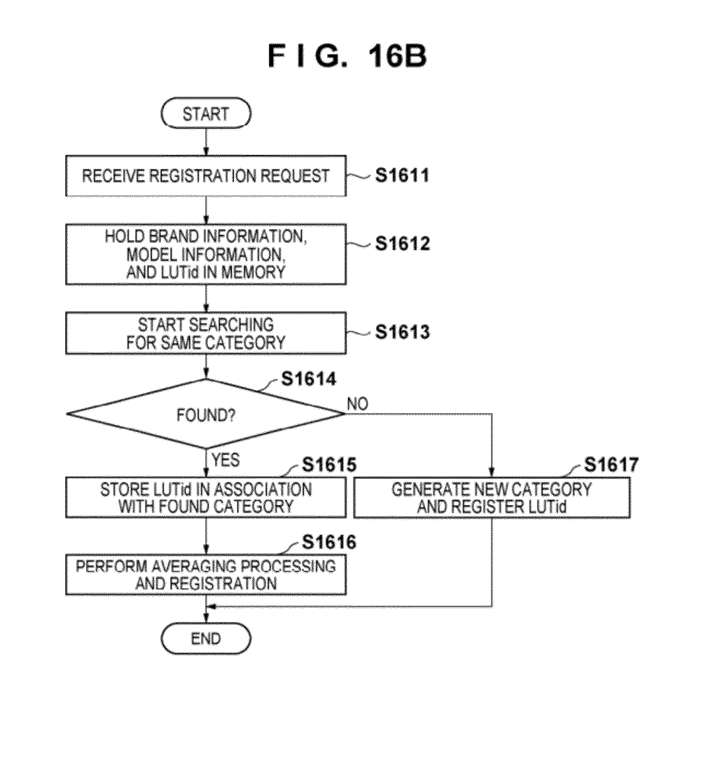

Response processing performed by the data server D with respect to a reference request will be described with reference to the flowchart of FIG. 16A. Assume that in this case, the image forming apparatus 100a has transmitted a reference request. However, when another image forming apparatus has transmitted a reference request, the same procedure as that described below is performed.

In step S1601, the CPU 1501 receives the above reference request from the image forming apparatus 100a by using the modem 1521.

In step S1602. the CPU 1501 reads out brand information and model information from the received request and stores them in the memory 1502.

In step S1603, the CPU 1501 starts searching the database stored in the memory 1502 by using the received brand information and model information as search keys. Assume that this database registers in advance pieces of LUTid corresponding to combinations (categories) of brand information and model information. That is, the database of the memory 1502 holds conversion setting information in association with each combination of brand information or physical characteristic information and model information indicating each image forming apparatus. In this manner, the CPU 1501 functions as a search unit which searches the database upon receiving a request from the image forming apparatus. The CPU 1501 also functions as a search unit which searches for and extracts conversion setting information corresponding to the combination of brand information or physical characteristic information and model information indicating the image forming apparatus, which are transmitted together with the request. Note that searching operation concerning physical characteristic information will be described in the embodiment described later.

In step S1604, the CPU 1501 determines whether the corresponding LUTid has been found (extraction has been succeeded). If the corresponding LUTid has been found, the process advances to step S1605.

In step S1605, the CPU 1501 transmits LUTid as a response to the image forming apparatus 100a, together with a success message. If LUTid could not found, the process advances to step S1606.

In step S1606, the CPU 1501 transmits a failure message as a response to the image forming apparatus 100a. In this manner, the CPU 1501 functions as a distribution unit which distributes the conversion setting information found by the search unit to the image forming apparatus.

<LUTid Registration Processing>

Response processing performed by the data server D with respect to a registration request will be described with reference to the flowchart of FIG. 16B. Assume that in this case, the image forming apparatus 100a has transmitted a registration request. However, when another image forming apparatus has transmitted a registration request, the same procedure as that described below is performed.

In step S1611, the CPU 1501 receives a registration request, together with brand information, model information, and LUTid.

In step S1612, the CPU 1501 temporarily stores the received brand information, model information, and LUTid in the memory 1502.

In step S1613, the CPU 1501 starts searching the database for LUTid belonging to the same category as that of the combination of received brand information and model information.

In step S1614, the CPU 1501 determines whether the same category has been found. If the same category has not been found, the process advances to step S1617 to generate a new category by combining the received brand information and model information and register LUTid in the database in association with the generated category. In contrast, if the same category has been found, the process advances to step S1615.

In step S1615, the CPU 1501 stores LUTid in the database of the memory 1502 in association with the found category.

In step S1615, the CPU 1501 generates average LUTid (LUTid_ave) by averaging a plurality of pieces of LUTid belonging to the same category. In addition, the CPU 1501 registers LUTid_ave in association with the category. Upon receiving a reference request, the CPU 1501 transmits LUTid_ave. As described above, the conversion setting information (LUTid_ave) transmitted from the server apparatus may be information obtained by averaging different pieces of conversion setting information transmitted from a plurality of image forming apparatuses.

Averaging pieces of LUTid generated by a plurality of image forming apparatuses in this manner can reduce measurement errors of the reader at the time of generation of LUTid and the individual differences between the printing medium Z and the printing medium X, which are used at the time of generation of LUTid. That is, it is possible to distribute more accurate pieces of LUTid to the image forming apparatuses 100a to 100d.

Note that this embodiment is configured to make the data server D store LUTid and transmit it to the image forming apparatus. However, LUTid is information which limits the amount of applied toner on a printing medium, and hence calibration using wrong LUTid will lead to the occurrence of image defects. For this reason, the server management person of the data server D may monitor LUTid received by the data server D and the model information of the image forming apparatus which has generated LUTid. Depending on a monitoring result, the CPU 1501 may delete improper LUTid from the database in accordance with an instruction from the server management person. This can maintain the accuracy and reliability of LUTid in the data server D.

### Effects of Invention in First Embodiment

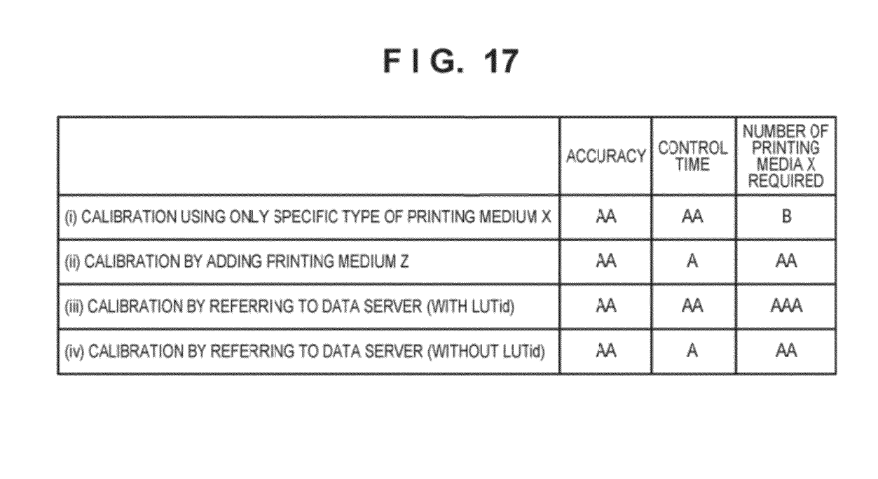

The effects of this embodiment will be described with reference to FIG. 17 from the viewpoint of calibration accuracy, calibration operation time (control time), and the number of printing media X of the specific type required. Case (i) is a case in which the apparatus has performed calibration by using only the printing medium X. Case (ii) is a case in which the apparatus has generated LUTid(Z) for the arbitrary type of printing medium Z, and has performed calibration by using the printing medium Z. Case (iii) is a case in which the apparatus has performed calibration upon obtaining LUTid(Z) for the printing medium Z from the data server D. Case (iv) is a case in which the apparatus has failed in an attempt to obtain LUTid(Z) for the printing medium Z from the data server D, and has performed calibration by using the printing medium Z upon generating LUTid. The respective calibration results are evaluated with four ratings, namely AAA (very good), AA (good), A (slightly poor), and B (poor).

In case (i), since the apparatus performs calibration by using only the printing medium X designated by the maker, the accuracy and control time are rated “good”, but the number of printing media X required tends to be large. This is because, the printing medium X needs to be prepared for every calibration. Furthermore, there is a demerit that the apparatus cannot perform calibration without the printing medium X. For this reason, the evaluation concerning the number of printing media X required is at the lowest level.

In case (ii), since the apparatus performs calibration by using the printing medium Z upon generating LUTid(Z) for the printing medium Z, the accuracy obtained is almost the same as that in case (i). Therefore, the accuracy is rated “good”. However, in case (ii), it is necessary to perform adding operation for LUTid(Z), and hence the control time required is longer than that in case (i). Therefore, the evaluation concerning the control time is determined as “slightly poor”. The number of printing media X required for adding operation for LUTid(Z) is only one. In addition, once the printing medium Z is added, there is no need to use the printing medium X for subsequent calibration. This is convenient for the operator. Therefore, the number of printing media X required is rated “good”.

In case (iii), since the apparatus performs calibration by using the printing medium Z upon downloading LUTid(Z) for the printing medium Z from the data server D, the accuracy is rated “good”. In addition, since it is only required to download LUTid(Z) from the data server D instead of generating it, the control time is also rated “good”. The number of printing media X required is rated highest among the four cases, because there is no need to use any printing medium X.

In case (iv), the apparatus fails to obtain LUTid(Z) from the data server D, and performs calibration by using the printing medium Z upon generating LUTid(Z). For this reason, the control time is rated “slightly poor”. Note however that the accuracy is rated “good”. In addition, the number of printing media X required in case (iv) is the same as that in case (ii), and hence is rated “good”.

As described above, this embodiment has a merit that it can perform calibration for a given type of printing medium X by using another type of printing medium Z. In cases (ii) and (iv), in particular, it is possible to add another type of printing medium Z which can be used for calibration, by using only one printing medium X of the specific type designated in advance by the maker. Furthermore, in case (iv), it is possible to perform calibration by using the printing medium Z without using any printing medium X. This eliminates the necessity to prepare the printing medium X, and hence provides convenience for the operator. That is, the same calibration result as that obtained by using the printing medium X can be obtained by using the arbitrary type of printing medium Z which the operator can easily obtain. Sharing LUTid(Z) by using the data server D to which a plurality of image forming apparatuses are connected can reduce the operation load on the operator. In addition, using the information obtained by averaging pieces of LUTid obtained by a plurality of image forming apparatuses will reduce the influence of the malfunction of the image forming engine in one of the image forming apparatuses.

### Second Embodiment

### Classification According to Grammage/Surface Property

The first embodiment is configured to make the data server D hold LUTid for each category which is a combination of the model information of an image forming apparatus and the brand information of a printing medium. However, information for specifying the type of printing medium is not limited to brand information but may be physical characteristic information indicating the physical characteristics of a printing medium. The second embodiment therefore proposes an invention designed to manage LUTid in accordance with each category which is a combination of the model information of an image forming apparatus and the physical characteristic information (for example, grammage and surface property) of a printing medium. For the sake of simplicity, the same reference numerals as in the first embodiment denote common portions.

[Procedure for Adding Operation in Image Forming Apparatus]

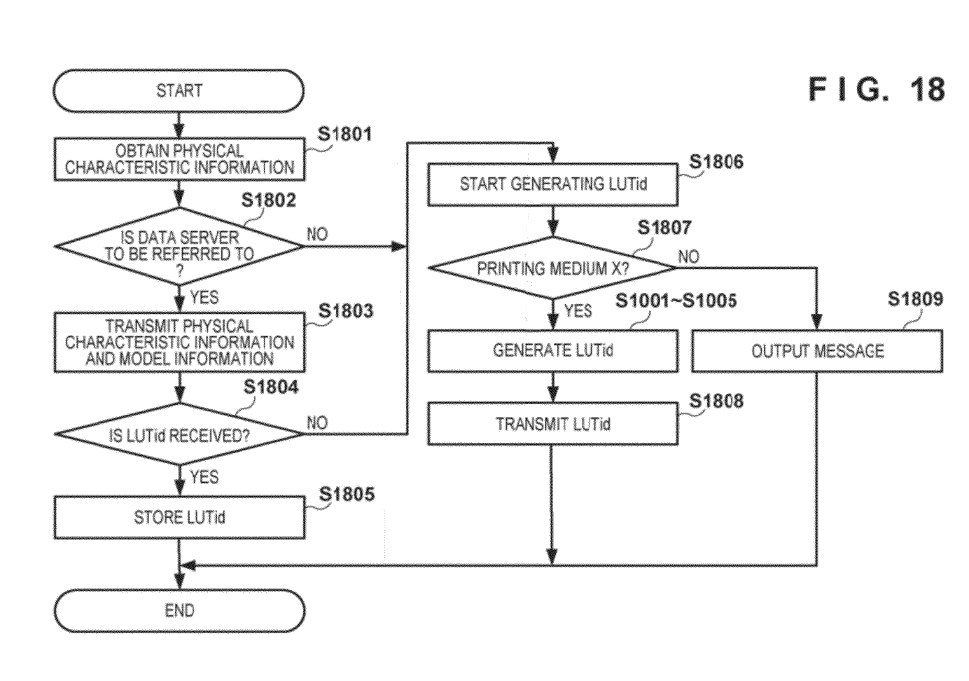

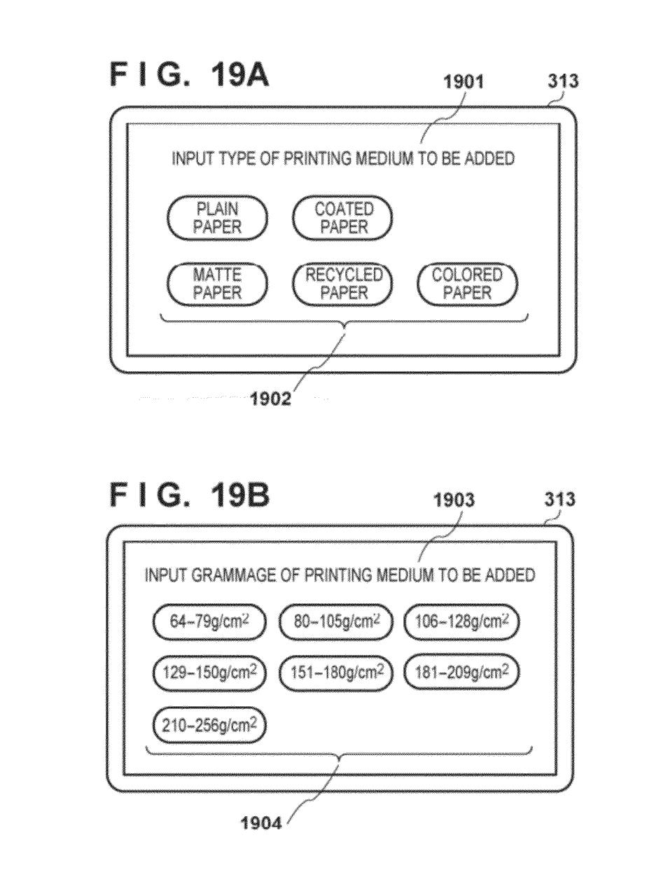

Adding processing performed by the image forming apparatus will be described with reference to FIG. 18. In this case, upon detecting that the user has touched a button for issuing an instruction to start adding operation, which is displayed on the display unit of an operation unit 313, a CPU 301 starts this processing. The CPU 301 displays, on the display unit of the operation unit 313, a message to prompt the operator to input physical characteristic information (for example, grammage and surface property) indicating a printing medium Z to be added. As shown in FIGS. 19A and 19B, the apparatus displays, on the operation unit, messages 1901 and 1903 which prompt the operator to input, buttons 1902 for selecting the type of surface property, and buttons 1904 for selecting grammage.

In step S1801, the CPU 301 receives the physical characteristic information input from the operation unit 313. That is, the CPU 301 or the operation unit 313 functions as a physical characteristic obtaining unit which obtains physical characteristic information indicating the physical characteristics of a printing medium whose type is different from the specific type. Assume that in this case, information representing a surface property and information representing grammage are input as physical characteristic information. However, a physical characteristic may be at least one of the surface property of a printing medium and grammage, or another physical characteristic information may be used.

In step S1802, the CPU 301 determines, based on the information input from the operation unit 313, whether to refer to LUTid in a data server D. When the CPU 301 detects a signal indicating that the operator has operated a button indicating an attempt to refer to, the process advances to step S1803. When the CPU 301 detects a signal indicating that the operator has operated a button indicating an attempt not to refer to, the process advances to step S1806.

In step S1803, the CPU 301 transmits a reference request to the data server D via a modem 321. For example, the CPU 301 reads out the physical characteristic information of the printing medium Z stored in a memory 302, and also reads out model information indicating the model of an image forming apparatus 100a stored in the memory 302. The CPU 301 generates and transmits a reference request containing or accompanied by physical characteristic information and model information. The CPU 301 therefore functions as a request unit which requests the server apparatus to transmit conversion setting information corresponding to the physical characteristic information.

In step S1804, the CPU 301 determines whether LUTid corresponding to a printing medium Z to be added could be received from the data server D. If the CPU 301 could receive LUTid together with a search success message, the process advances to step S1805.

In step S1805, the CPU 301 stores the received LUTid in the ROM portion of the memory 302 in association with the physical characteristic information of the printing medium Z, and then terminates this processing. This makes it possible to perform calibration by using the printing medium Z instead of the printing medium X. Upon receiving physical characteristic information via the operation unit 313 in step S1201, the CPU 301 sets LUTid corresponding to the physical characteristic information in step S1202, and generates LUTa in step S1203. If the CPU 301 receives a search failure message in step S1804, the process advances to step S1806.

In step S1806, the CPU 301 starts generating LUTid(Z) corresponding to the printing medium Z. To generate LUTid(Z), the CPU 301 requires not only the printing medium Z but also the specific type of printing medium X. As shown in FIG. 14A, the CPU 301 displays a message 1401 and buttons 1402 and 1403 on the display unit of the operation unit 313.

In step S1807, the CPU 301 determines, based on the information input from the operation unit 313, whether the printing medium X is set on the tray. If the printing medium X is set on the tray, the CPU 301 generates LUTid(Z) by performing steps S1001 to S1005. The process then advances to step S1808.

In step S1808, the CPU 301 transmits (uploads) the generated LUTid(Z) and a registration request containing or accompanied by model information and physical characteristic information, and then terminates this processing. The data server D registers LUTid(Z) in the database in association with model information and physical characteristic information. This allows image forming apparatuses 100b to 100d of the same model as that of the image forming apparatus 100a to use LUTid(Z) by downloading it from the data server D instead of generating LUTid(Z).

If the printing medium X is not set on the tray (the button 1403 is operated), the process advances to step S1809.

In step S1809, the CPU 301 outputs the message 1404 to the display unit of the operation unit 313.

<Response Processing for Reference Request>

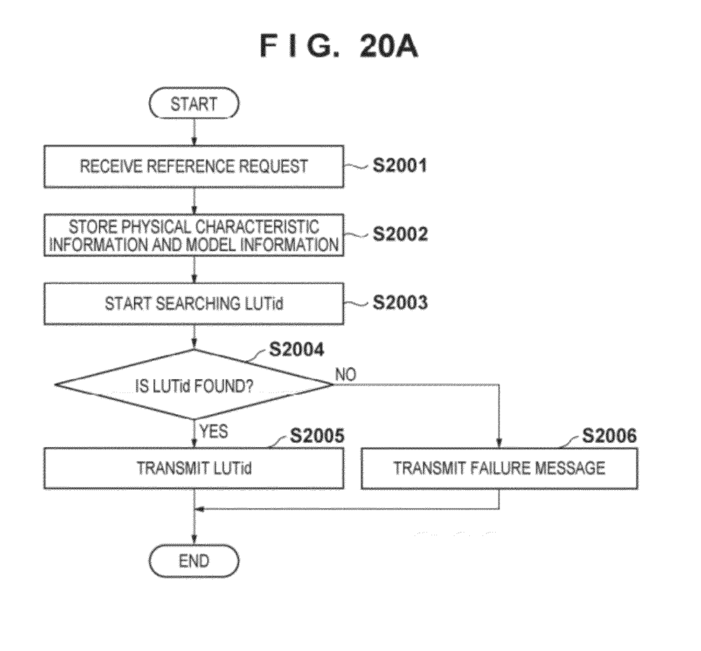

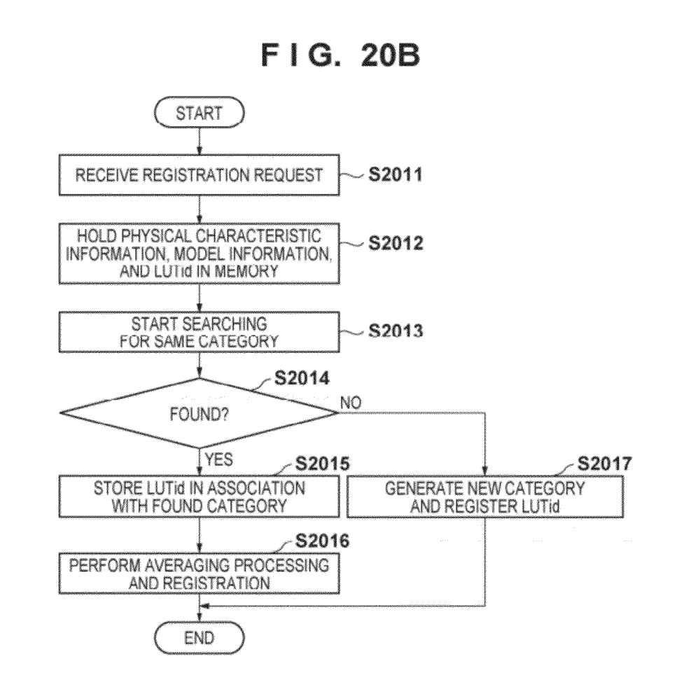

Response processing performed by the data server D for a reference request will be described with reference to the flowchart shown in FIG. 20A. Assume that in this case, the image forming apparatus 100a has transmitted a reference request. However, when another image forming apparatus has transmitted a reference request, the same procedure as that described below is performed.

In step S2001, a CPU 1501 receives the reference request described above from the image forming apparatus 100a by using a modem 1521.

In step S2002, the CPU 1501 reads out the physical characteristic information and the model information from the received request, and stores them in a memory 1502.

In step S2003, the CPU 1501 starts searching the database stored in the memory 1502 by using the received physical characteristic information and model information as search keys. Assume that the database registers in advance LUTid corresponding to each combination (category) of physical characteristic information and model information.

In step S2004, the CPU 1501 determines whether the corresponding LUTid has been found (successfully extracted). If the LUTid has been found, the process advances to step S2005.

In step S2005, the CPU 1501 transmits the LUTid as a response, together with a search success message, to the image forming apparatus 100a. In contrast, if the LUTid could not be found, the process advances to step S2006.

In step S2006, the CPU 1501 transmits a failure message as a response to the image forming apparatus 100a.

<Registration Processing for LUTid>

Response processing performed by the data server D in response to a registration request will be described with reference to the flowchart shown in FIG. 20B. Assume that in this case, the image forming apparatus 100a has transmitted a registration request. However, when another image forming apparatus has transmitted a registration request, the same procedure as that described below is performed.

In step S2011, the CPU 1501 receives a registration request together with physical characteristic information, model information, and LUTid.

In step S2012, the CPU 1501 temporarily stores the received physical characteristic information, model information, and LUTid in the memory 1502.

In step S2013, the CPU 1501 starts searching the database for LUTid belonging to the same category as that of the combination of the received physical characteristic information and model information. If the physical characteristic information includes surface property information and grammage information, one category is defined by one of the surface property information, the grammage information, and the model information.

In step S2014, the CPU 1501 determines whether the same category could be found. To determine that given LUTid belongs to the same category, search keys need to match entries in the database in terms of all pieces of information including surface property information, grammage information, and model information. If the same category could not be found, the process advances to step S2017 to generate a new category by combining the received physical characteristic information and model information, and registers LUTid in the database in association with the generated category. If the same category could be found, the process advances to step S2015.

In step S2015, the CPU 1501 stores the LUTid in the database of the memory 1502 in association with the found category.

In step S2016, the CPU 1501 generates LUTid (LUTid_ave) by averaging a plurality of pieces of LUTid belonging to the same category. In addition, the CPU 1501 registers the LUTid_ave in the database in association with the category. Upon receiving a reference request, the CPU 1501 transmits the LUTid_ave. Note that the technical significance of averaging processing is the same as that described above.

### Effects of Invention according to Second Embodiment

The second embodiment differs from the first embodiment only in that it uses physical characteristic information such as surface property information and grammage information in place of brand information in the first embodiment, and hence has the same effects as those of the first embodiment. Note however that since brand information changes for each paper maker, even printing media having almost the same physical characteristics are handled as different types of printing media. That is, the data servers D and the image forming apparatuses 100a to 100d recognize even printing media of substantially the same type as different types of printing media in the first embodiment, and hence the databases tend to expand. In addition, since the parameter of LUTid decreases, the effect of averaging tends to decrease. Furthermore, since the number of times that it is determined that LUTid does not exist in the data server D increases, the operation load on the operator tends to increase. In contrast to this, according to the second embodiment, the data servers D and the image forming apparatuses 100a to 100d recognize printing media having the same physical characteristics as those belonging to the same category even if they differ in brand. This is very advantageous in improving the efficiency of databases, improving the effect of averaging, and reducing operation load.

### Third Embodiment

### Limitations on Transmission to Data Acquisition/Distribution Device

The invention described in the first and second embodiments is configured to directly transmit the LUTid generated by the image forming apparatus to the data server. LUTid is information shared by a plurality of image forming apparatuses, and is important information which greatly influences the quality of images output from the image forming apparatuses. Therefore it can impose some limitations when generated LUTid is to be directly registered in the data server. The third embodiment is therefore configured to determine, in accordance with information about the person who has generated LUTid, whether to permit or inhibit transmission to a data server D, and impose some limitations on registration in the data server D. This embodiment will be described based on the first embodiment, but may be based on the second embodiment.

[Adding Processing in Image Forming Apparatus]

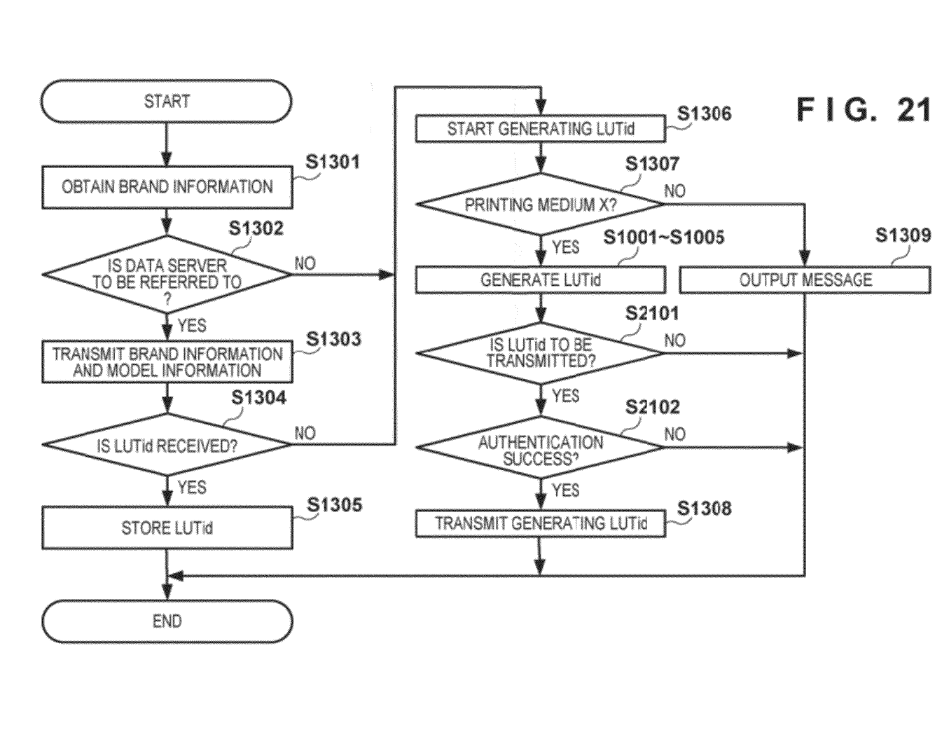

FIG. 21 is a flowchart based on FIG. 13, which flowchart additionally includes steps S2101 and S2102. When LUTid is generated through steps S1001 to S1005, the process advances to step S2102.

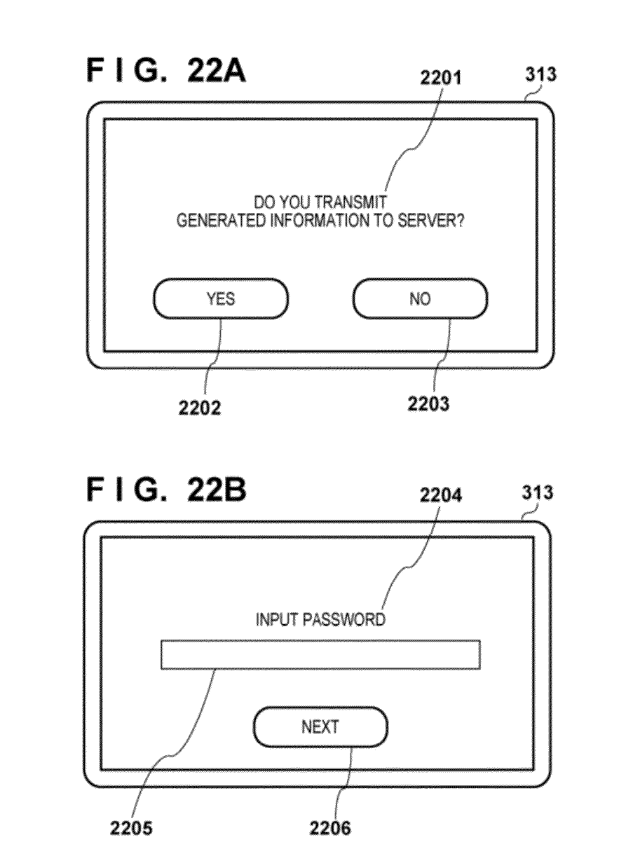

In step S2101, a CPU 301 determines whether to transmit the generated LUTid to the data server D. For example, the CPU 301 displays a message 2201 like that shown in FIG. 22A on the display unit of an operation unit 313. The message 2201 is a message for inquiring the operator whether to transmit LUTid to the data server D. In this manner, the CPU 301 and the display unit of the operation unit 313 each function as an output unit which outputs a message for inquiring the operator whether to transmit the conversion setting information generated by the generation unit to the server apparatus. Upon detecting that the operator has operated a button 2202 indicating a positive intention, the CPU 301 determines that the operator will transmit the generated LUTid to the data server D. The process then advances to step S2102. In contrast, upon detecting that the operator has operated a button 2203 indicating a negative intention, the CPU 301 determines that the operator will not transmit the generated LUTid to the data server D, and terminates this processing. In this manner, the CPU 301 or the input unit of the operation unit 313 functions as an acceptance unit which accepts selection information indicating that the operator has selected whether to transmit conversion setting information to the server apparatus.

In step S2102, the CPU 301 determines whether the operator has succeeded in authentication. For example, the CPU 301 displays a message 2204 like that shown in FIG. 22B on the display unit. When the operator inputs the password set in advance by the administrator of the image forming apparatus to a text box 2205 and presses a button 2206, the CPU 301 performs authentication processing. For example, the CPU 301 compares the input password with the password stored in the memory 302 in advance. If they match, the CPU 301 estimates that the operator is an authorized administrator. The process then advances to step S1308. In this manner, the CPU 301 functions as an authentication unit which authenticates whether the operator of the image forming apparatus is a predetermined operator.

In step S1308, as described above, the CPU 301 transmits the LUTid to the data server D. The CPU 301 therefore functions as a transmission unit which transmits conversion setting information to the server apparatus when the operator selects to transmit the conversion setting information to the server apparatus. In addition, the CPU 301 functions as a transmission unit which transmits conversion setting information to the server apparatus when the authentication unit authenticates that the operator of the image forming apparatus is a predetermined operator. On the other hand, when authentication fails, the CPU 301 terminates this processing without transmitting the LUTid to the data server D.

Note that although the flowchart shown in FIG. 21 indicates that generated LUTid is not sometimes transmitted to the data server D, since the LUTid is held in the image forming apparatus which has generated it (S1005), the information is used in the apparatus.

It is possible to apply the invention described in the third embodiment to the second embodiment by inserting steps S2101 and S2102 between steps S1005 and S1808 in the same manner as described above.

### Effects of Invention according to Third Embodiment

As described above, since LUTid is information which imposes limitation on the amount of applied toner on printing medium, performing calibration by using wrong LUTid may lead to the occurrence of an image defect. This may also impose a heavy load on the image forming apparatus. Furthermore, registering this wrong LUTid in the data server D will affect other image forming apparatuses.

Controlling the transmission of LUTid to the data server D by using authentication processing as in the third embodiment will facilitate suppressing such adverse effect. When an unexpected trouble occurs in the process of generating LUTid, the operator can inhibit the transmission of LUTid to the data server D according to his/her own will. The third embodiment therefore facilitates maintaining the accuracy and reliability of LUTid.

### Fourth Embodiment

### Comparing Transmitted Conversion LUTid with LUTid_ave Obtained by Averaging Processing

One of the features of the first to third embodiments is that the data server D performs averaging processing of pieces of LUTid received from image forming apparatuses and provides the resultant information to other image forming apparatuses. However, performing averaging processing of all the pieces of LUTid unconditionally may fail to obtain intended LUTid. For example, the LUTid generated by an image forming apparatus in which some kind of trouble has occurred greatly deviates from proper LUTid, and hence should not be used for averaging processing.

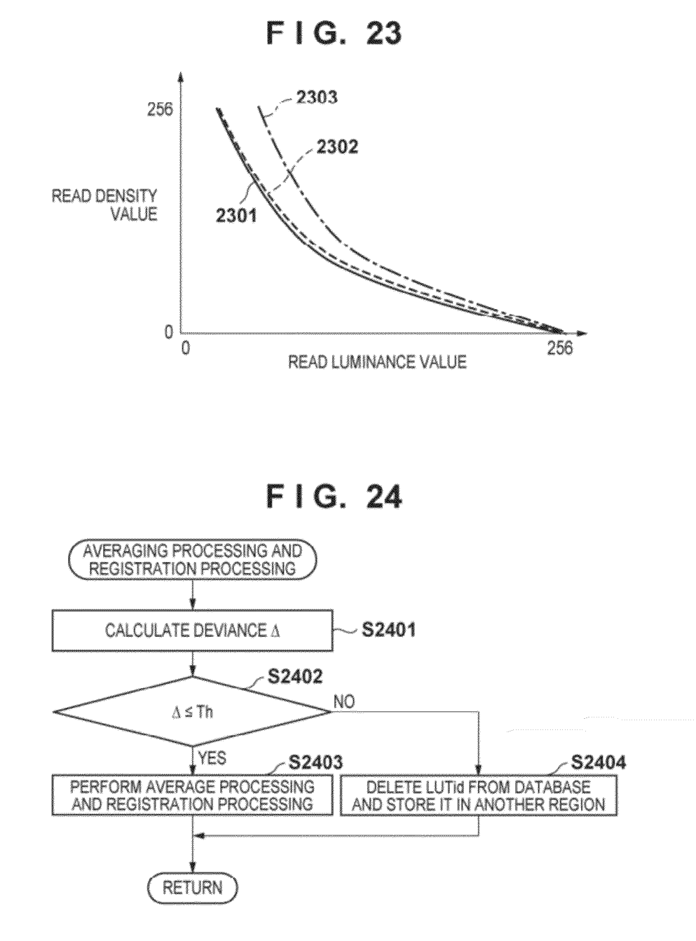

Referring to FIG. 23, reference numeral 2301 denotes LUTid_ave obtained by averaging processing of pieces of LUTid generated by image forming apparatuses which operates normally; and 2302, LUTid generated by an image forming apparatus which operates normally. Obviously from FIG. 23, the LUTid generated by the image forming apparatus which operates normally has characteristics similar to those of LUTid_ave. On the other hand, reference numeral 2303 denotes LUTid generated by an image forming apparatus in which a trouble has occurred. The LUTid generated by the image forming apparatus in which the trouble has occurred may show a considerable deviance from the LUTid_ave.

Using such LUTid for averaging processing will degrade the accuracy of LUTid_ave. The third embodiment therefore determines in advance whether to use received LUTid for averaging processing, and generates LUTid_ave by using only usable LUTid.

### Averaging Processing of LUTid in Fourth Embodiment

The fourth embodiment is configured to exclude any LUTid received by the data server D which shows a predetermined deviance or more from LUTid_ave from targets for averaging processing. Assume that, as shown in FIG. 23, LUTid is regarded as a luminance/density conversion curve, and I (taking 1 to 256) and D(I) (also taking 1 to 256) respectively represent a read luminance value and a corresponding density value. In addition, the luminance value of LUTid_ave is represented by D_ave(I), and the density value of LUTid newly transmitted from an image forming apparatus is represented by D_new(I).

It is possible to express the deviance between the newly transmitted LUTid and LUTid_ave by the root mean square (variance) of errors of D_new(I) with respect to D_ave(I). An index Δ representing a deviance is given by

$$Δ = \sqrt{\frac{{\sum }_{l = 1}^{256} {( D\_new ( I ) - D\_ave ( I ) )}^{2}}{256}}$$

where Δ represents the absolute value of the difference between D_new(I) and D_ave(I) per luminance value level. For example, Δ=10 indicates that the average deviance between newly transmitted LUTid and LUTid_ave is 10 levels.

In the fourth embodiment, if Δ is larger than a predetermined threshold Th (for example, 10), the apparatus estimates that newly transmitted LUTid has undergone some trouble, and hence excludes it from targets for averaging processing. If Δ is equal to or less than Th, the apparatus sets the newly transmitted LUTid as a target for averaging processing.

[Procedure to be Performed when Conversion LUTid is Received]

FIG. 24 shows a concrete example of step S1616 or S2016 described above.

In step S2401, a CPU 1501 calculates the index Δ indicating the deviance of newly received LUTid relative to LUTid_ave according to the above equation.

In step S2402, the CPU 1501 determines, based on the received LUTid and LUTid_ave, whether to set the LUTid as a target for averaging processing. For example, the CPU 1501 determines whether the index Δ is equal to or less than the threshold Th. In this manner, the CPU 1501 functions as a determination unit which determines the variance between the conversion setting information received from an image forming apparatus and distribution conversion setting information registered in the database and distributed to a plurality of image forming apparatuses.

If Δ is larger than Th, since the received LUTid is not proper, the process advances to step S2404.

In step S2404, the CPU 1501 deletes the received LUTid from the database, and stores it as defective information in another region ensured in a memory 1502. In this manner, the CPU 1501 functions as a registration unit which rejects the registration of the conversion setting information received from an image forming apparatus in the database if the deviance exceeds the predetermined threshold.

If Δ is equal to or less than Th, since the received LUTid is proper, the process advances to step S2403.

In step S2403, the CPU 1501 adds the received LUTid as a target for averaging processing, recalculates LUTid_ave, and registers the resultant information in the database. In this manner, the CPU 1501 functions as a registration unit which registers the conversion setting information received from an image forming apparatus in the database if the deviance is equal to or less than the predetermined threshold. The CPU 1501 also functions as a generation unit which generates distribution conversion setting information by performing averaging processing of different pieces of conversion setting information received from a plurality of image forming apparatuses of the same model.

### Effects of Invention according to Fourth Embodiment

The fourth embodiment can maintain the accuracy of LUTid_ave by excluding the LUTid received by the data server D from targets for averaging processing if the deviance between the LUTid and the LUTid_ave is equal to or more than a predetermined value. Note that when LUTid is registered in the database for the first time or the number of pieces of LUTid registered is around a single digit, the accuracy of LUTid_ave may not be sufficient. For this reason, the CPU 1501 may exclude improper LUTid by applying the fourth embodiment after the number of pieces of LUTid registered becomes a statistically sufficient number (predetermined number).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-274918, filed Dec. 9, 2010 which is hereby incorporated by reference herein in its entirety.

What is claimed is:

1. An image forming apparatus for performing calibration to maintain a quality of an image by using a specific type of printing medium, the apparatus comprising:
a request unit configured to request a server apparatus for conversion setting information for converting a luminance value required to perform the calibration into a density value by using a printing medium whose type is different from the specific type;
a reception unit configured to receive the conversion setting information from the server apparatus;
a storage unit configured to store the conversion setting information received from the server unit; and
a calibration performing unit configured to perform calibration by using the conversion setting information stored in said storage unit and the printing medium of the type different from the specific type of printing medium.

2. The apparatus according to claim 1, further comprising a generation unit configured to generate the conversion setting information and causes said storage unit to store the conversion setting information when the conversion setting information has not been received from the server apparatus.

3. The apparatus according to claim 1, comprising a brand information obtaining unit configured to obtain brand information indicating a brand of a printing medium whose type is different from the specific type,
wherein said request unit requests the server apparatus for the conversion setting information corresponding to the brand information.

4. The apparatus according to claim 3, wherein said brand information obtaining unit comprises a barcode reader which reads brand information in a barcode form indicating a brand of a printing medium.

5. The apparatus according to claim 1, further comprising a physical characteristic obtaining unit configured to obtain physical characteristic information indicating a physical characteristic of the printing medium of the type different from the specific type of printing medium,
wherein said request unit requests the server apparatus for the conversion setting information corresponding to the physical characteristic information.

6. The apparatus according to claim 5, wherein the physical characteristic is at least one of a surface property and grammage of the printing medium.

7. The apparatus according to claim 1, further comprising a model information obtaining unit configured to obtain model information indicating a model of the image forming apparatus,
wherein said request unit requests the server apparatus for the conversion setting information corresponding to the model information.

8. The apparatus according to claim 1, further comprising a transmission unit configured to cause the server apparatus to register the conversion setting information generated by said generation unit by transmitting the conversion setting information to the server apparatus.

9. The apparatus according to claim 8, further comprising
an output unit configured to output a message for inquiring an operator whether to transmit the conversion setting information generated by said generation unit to the server apparatus, and
an acceptance unit configured to accept selection information indicating that the operator has selected whether to transmit the conversion setting information to the server apparatus,
wherein said transmission unit transmits the conversion setting information to the server apparatus when the operator has selected to transmit the conversion setting information to the server apparatus.

10. The apparatus according to claim 8, further comprising an authentication unit configured to authenticate whether an operator of the image forming apparatus is a predetermined operator,
wherein said transmission unit transmits the conversion setting information to the server apparatus when said authentication unit authenticates that the operator of the image forming apparatus is the predetermined operator.

11. The apparatus according to claim 1, wherein the conversion setting information transmitted from the server apparatus is information obtained by averaging different pieces of conversion setting information respectively transmitted from a plurality of image forming apparatuses.

12. A server apparatus which operates in cooperation with the image forming apparatus defined in claim 1, the server apparatus comprising:
a database which registers the conversion setting information in association with one of brand information indicating a brand of a printing medium and a physical characteristic of the printing medium;
a search unit configured to search the database upon receiving the request from the image forming apparatus; and
a distribution unit configured to distribute the conversion setting information found by said search unit to the image forming apparatus.

13. The apparatus according to claim 12, wherein the database holds the conversion setting information in association with a combination of one of the brand information and the physical characteristic information and model information indicating the image forming apparatus, and
said search unit searches for and extracts the conversion setting information corresponding to a combination of one of the brand information and the physical characteristic information and the model information indicating the image forming apparatus, which are transmitted together with the request.

14. The apparatus according to claim 13, further comprising
a determination unit configured to determine a deviance between the conversion setting information received from the image forming apparatus and distribution conversion setting information which is registered in the database and distributed to a plurality of image forming apparatuses, and
a registration unit configured to reject registration of the conversion setting information received from the image forming apparatus in the database if the deviance exceeds a predetermined threshold, and registers the conversion setting information received from the image forming apparatus in the database if the deviance is not more than the predetermined threshold.

15. The apparatus according to claim 14, further comprising a generation unit configured to generate the distribution conversion setting information by performing averaging processing of different pieces of conversion setting information respectively received from a plurality of image forming apparatuses of the same model.

16. An image forming system comprising:
an image forming apparatus for performing calibration to maintain a quality of an image by using a specific type of printing medium, the apparatus comprising:
a request unit configured to request a server apparatus for conversion setting information for converting a luminance value required to perform the calibration into a density value by using a printing medium whose type is different from the specific type;
a reception unit configured to receive the conversion setting information from the server apparatus;
a storage unit configured to store the conversion setting information received from the server unit; and
a calibration performing unit configured to perform calibration by using the conversion setting information stored in said storage unit and the printing medium of the type different from the specific type of printing medium; and
the server apparatus which operates in cooperation with the image forming apparatus, server apparatus comprising:
a database which registers the conversion setting information in association with one of brand information indicating a brand of a printing medium and a physical characteristic of the printing medium;
a search unit configured to search the database upon receiving the request from the image forming apparatus; and
a distribution unit configured to distribute the conversion setting information found by said search unit to the image forming apparatus.
